(19) United States
(12) Patent Application Publication
(10) Pub. No.: US 2025/0119944 A1
(43) Pub. Date: Apr. 10, 2025

(54) TURNING ON AND TURNING OFF RELAY FUNCTIONALITY OF A RELAY NODE IN A WIRELESS NETWORK

(71) Applicant: NEWRACOM, Inc., Irvine, CA (US)

(72) Inventors: Yeon-Geun LIM, Seoul (KR); Si-Chan NOH, Seoul (KR); Joonsoo LEE, Seoul (KR)

(73) Assignee: NEWRACOM, Inc., Irvine, CA (US)

(21) Appl. No.: 18/912,505

(22) Filed: Oct. 10, 2024

Related U.S. Application Data
(60) Provisional application No. 63/589,157, filed on Oct. 10, 2023.

(51) Int. Cl. H04W 74/0808; H04W 16/26

(52) U.S. Cl. CPC H04W 74/0808; H04W 16/26

(57) ABSTRACT

An embodiment is a method performed by a source node to transmit data to a destination node via a relay node. The method includes transmitting a control frame to the relay node to indicate that the relay node is to turn on relay functionality and transmitting a data frame to the destination node via the relay node while relay functionality of the relay node is turned on. An embodiment is a method performed by a relay node to relay data transmitted by a source node to a destination node. The method includes receiving a control frame from the source node that indicates that the relay node is to turn on relay functionality, turning on relay functionality of the relay node responsive to receiving the control frame, and relaying a data frame transmitted by the source node to the destination node while relay functionality of the relay node is turned on.

### CROSS-REFERENCE TO RELATED APPLICATION

This application claims the benefit of U.S. Provisional Application No. 63/589,157 filed Oct. 10, 2023, which is hereby incorporated by reference.

### TECHNICAL FIELD

The present disclosure generally relates to wireless communications, and more specifically, relates to turning on and turning off relay functionality of a relay node in a wireless network.

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHZ, 6 GHZ, and 60 GHz bands. These standards define the protocols that enable Wi-Fi devices to communicate with each other. The IEEE 802.11 family of standards has evolved over time to accommodate higher data rates, improved security, and better performance in different environments. Some of the most widely used standards include 802.11a, 802.11b, 802.11g, 802.11n, 802.11ac, and 802.11ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

IEEE 802.11be, also known as “Wi-Fi 7”, is the next generation of the IEEE 802.11 family of standards for wireless local area networks. Currently under development, 802.11be aims to significantly improve upon the capabilities of its predecessor, 802.11ax/Wi-Fi 6, by offering even higher data rates, lower latency, and increased reliability. The standard is expected to leverage advanced technologies such as multi-link operation (MLO), which allows devices to simultaneously use multiple frequency bands and channels for enhanced performance and reliability. Additionally, 802.11be will introduce 4096-QAM (Quadrature Amplitude Modulation), enabling higher data rates by encoding more bits per symbol. The standard will also feature improved medium access control (MAC) efficiency, enhanced power saving capabilities, and better support for high-density environments. With these advancements, 802.11be is expected to deliver theoretical maximum data rates of up to 46 gigabits per second (Gbps), making it suitable for bandwidth-intensive applications such as virtual and augmented reality, 8K video streaming, and high-performance gaming. The IEEE 802.11be standard is projected to be finalized by the end of 2024, paving the way for the next generation of Wi-Fi devices and networks.

The scope of future wireless networking standards (e.g., beyond IEEE 802.11bc) includes technologies for rate-vs-range throughput improvements. One such technology is relay technology in which a relay node relays data transmitted by a source node to a destination node. There are two types of relay mechanisms. One is a decode-and-forward (DF) relay mechanism and the other is an amplify-and-forward (AF) relay mechanism. With the DF relay mechanism, a relay node decodes, re-encodes, and forwards the received signal to the destination node. With the AF relay mechanism a relay node amplifies and retransmits the received signal to the destination node without decoding the signal. The AF relay mechanisms has at least the following benefits compared to the DF relay mechanism: lower computational cost and lower latency for data exchange.

In a relay system, forwarded data should be protected, taking into consideration the hidden node problem caused by the extended transmission range of the relay node. Various transmission opportunity (TXOP) sharing procedures have been introduced to solve this problem in a DF relay scenario. For example, the IEEE 802.11ah wireless networking standard specifies TXOP sharing and protection procedures that use explicit/implicit acknowledgements (ACK). Also, the IEEE 802.11 Ultra High Reliability (UHR) study group (SG) has discussed a TXOP sharing for DF relay that re-uses MU RTS TXS sequence. In an AF relay system, the legacy request-to-send (RTS) frame and clear-to-send (CTS) frame exchange directly passing through the AF relay node can protect the forwarded data. However, this legacy RTS frame and CTS frame exchange-based protection requires that the AF relay node always has its relay functionality turned on, even when there is no data to be relayed. The relay functionality of the AF relay always being turned on may result in at least the following issues: unexpected noise and interference can be amplified and forwarded by the relay node even when there is no data to be relayed to a destination node and power of the relay node can be wasted.

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a Carrier Sense Multiple Access with Collision Avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in Extremely High Throughput (EHT) Physical Protocol Data Unit (PPDU) frames, including their purposes and characteristics, in accordance with some embodiments of the present disclosure.

FIG. 8 illustrates an example of multi-user (MU) transmission in Orthogonal Frequency-Division Multiple Access (OFDMA), in accordance with some embodiments of the present disclosure.

FIG. 9 illustrates an example of an access point sending a trigger frame to multiple associated stations and receiving Uplink Orthogonal Frequency-Division Multiple Access Trigger-Based Physical Protocol Data Units (UL OFDMA TB PPDUs) in response, in accordance with some embodiments of the present disclosure.

FIG. 10 is a diagram showing an example of data being relayed using a DF relay mechanism, according to some embodiments.

FIG. 11 is a diagram showing an example of data being relayed using an AF relay mechanism, according to some embodiments.

FIG. 12A is a diagram showing the use of a trigger frame that includes a relay on time duration indicator to turn on relay functionality of an AF relay node, according to some embodiments.

FIG. 12B is a diagram showing the use of a trigger frame that includes a relay on time duration indicator to turn on relay functionality of an DF relay node, according to some embodiments.

FIG. 13 is a diagram showing the use of a trigger frame that includes a relay on/off indicator to turn on relay functionality, according to some embodiments.

FIG. 14 is a diagram showing the use of a trigger frame that includes a relay on time duration indicator and a periodicity of relay on time duration indicator to turn on relay functionality of an AF relay node, according to some embodiments.

FIG. 15 is a diagram showing the use of a MU RTS frame or MU RTS TXS frame to turn on relay functionality of an AF relay node, according to some embodiments.

FIG. 16 is a flow diagram of a method performed by a relay node for processing a MU RTS TXS frame based on Alt 1, according to some embodiments.

FIG. 17 is a flow diagram of a method for processing a MU RTS TXS frame based on Alt 2, according to some embodiments.

FIG. 18 is a flow diagram of a method for processing a MU RTS frame based on Alt 3, according to some embodiments.

FIG. 19 is a flow diagram of a method for processing a MU RTS frame based on Alt 4, according to some embodiments.

FIG. 20 is a flowchart of a method for transmitting data to a destination node via a relay node, according to some embodiments.

FIG. 21 is a flowchart of a method for relaying data transmitted by a source node to a destination node, according to some embodiments.

### DETAILED DESCRIPTION

The present disclosure generally relates to wireless communications, and more specifically, relates to turning on and turning off relay functionality of a relay node in a wireless network.

Existing relay systems require that a relay node always keep its relay functionality turned on, which can result in the relay node amplifying and forwarding unexpected noise and interference even when there is no data to be relayed to the destination node and can result in the relay node unnecessarily consuming power.

The present disclosure describes techniques for turning on and turning off relay functionality of a relay node in a wireless network. According to some embodiments, by default, a relay node has its relay functionality turned off (inactive) and the relay node only turns on its relay functionality when it receives a frame indicating that it should turn on its relay functionality. The relay node may subsequently turn off its relay functionality when it receives a frame indicating that the relay node should turn off its relay functionality. Various types of frames can be used for controlling relay functionality of the relay node. For example, an existing trigger frame that is not a multi-user request-to-send (MU RTS) transmission opportunity sharing (TXS) frame, a new trigger frame, or other type of control frame can be reused, extended, or defined to control relay functionality of the relay node. In an embodiment, a MU RTS (or MU RTS TXS) frame can be reused and extended to control relay functionality of the relay node.

According to some embodiments, a source node may transmit a control frame to the relay node to indicate that the relay node should turn on its relay functionality. Responsive to receiving the control frame, the relay node may turn on its relay functionality (which was previously turned off). The source node may then transmit a data frame to the destination node while relay functionality of the relay node is turned on. The relay node may relay the data frame transmitted by the source node to the destination node while relay functionality of the relay node is turned on.

In an embodiment, the control frame includes a relay on time duration indicator that indicates a time duration of a time period during which relay functionality is to be turned on. The relay node may determine a time duration of the time period during which relay functionality of the relay node is to be turned on based on the relay on time duration indicator included in the control frame. Responsive to receiving the control frame, the relay node may keep its relay functionality turned on for the indicated time duration and then turn off its relay functionality after the indicated time duration expires. In an embodiment, the relay node turns off its relay functionality early (before the indicated time duration expires) if, prior to the indicated time duration expiring, it receives a frame that includes relay on time duration indicator that indicates a time duration of zero.

In an embodiment, the control frame includes a relay on/off indicator that indicates that the relay node should turn on its relay functionality. Responsive to receiving the control frame, the relay node may turn on its relay functionality. The relay node may keep its relay functionality turned on until it receives a subsequent control frame that includes a relay/off indicator that indicates that the relay node should turn off its relay functionality.

In an embodiment, the control frame includes a relay on time duration indicator that indicates a time duration of each time period of a plurality of recurring time periods during which relay functionality of the relay node is to be turned on and a periodicity of relay on time duration indicator that indicates a periodicity of the plurality of recurring time periods. The relay node may determine a time duration of each recurring time period based on the relay on time duration indicator included in the control frame, and also determine a periodicity of the plurality of recurring time periods based on the periodicity of relay on time duration indicator included in the control frame. Responsive to receiving the control frame, the relay node may periodically turn on its relay functionality for the indicated time duration in accordance with the indicated periodicity. In an embodiment, the relay node turns off its periodic relay functionality if it receives a frame that includes relay on time duration indicator that indicates a time duration of zero.

The techniques described herein may provide one or more advantages. Since a relay node keeps its relay functionality turned off by default and only turns on its relay functionality when there is data to be relayed, the power consumption of the relay node is reduced. Also, in the case where the relay node uses an AF relay mechanism, the relay node does not amplify and forward unexpected noise and interference when there is no data to be relayed. The techniques described herein can protect the transmission of relayed data, taking into consideration the hidden node problem caused by the extended transmission range of the relay node. Also, the rate-vs-range throughput in the wireless network can be increased by virtue of the relay operations. While certain advantages are mentioned here, one of ordinary skill in the relevant art will appreciate that the techniques disclosed herein may have other advantages in view of the present disclosure.

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in different ways, all without departing from the spirit or scope of the present invention. Accordingly, the drawings and description are to be regarded as illustrative in nature and not restrictive. Like reference numerals designate like elements throughout the specification.

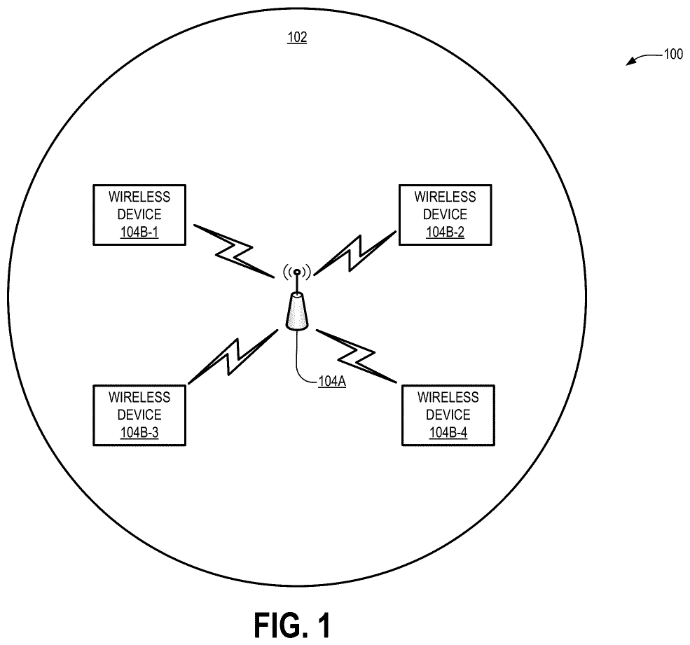

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B1-104B4 that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B1-104B4) may be collectively referred to as STAs. However, for case of description, only the non-AP STAs may be referred to as STAs unless the context indicates otherwise. Although shown with four non-AP STAs (e.g., the wireless devices 104B1-104B4), the WLAN 100 may include any number of non-AP STAs (e.g., one or more wireless devices 104B).

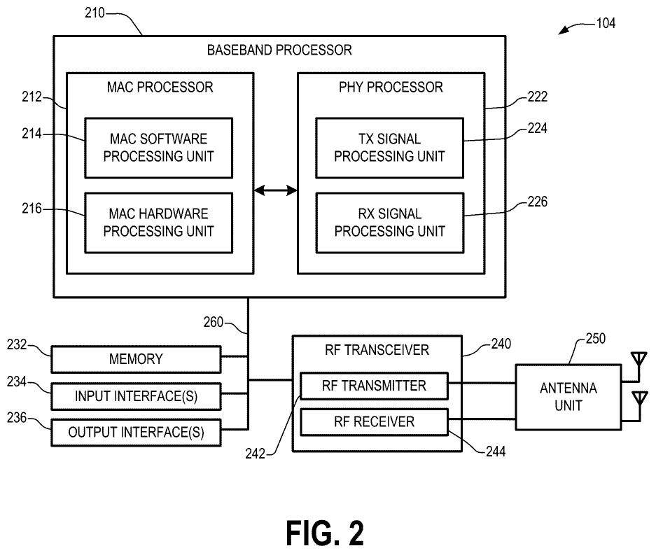

FIG. 2 illustrates a schematic block diagram of a wireless device 104, according to an embodiment. The wireless device 104 may be the wireless device 104A (i.e., the AP of the WLAN 100) or any of the wireless devices 104B1-104B4 in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

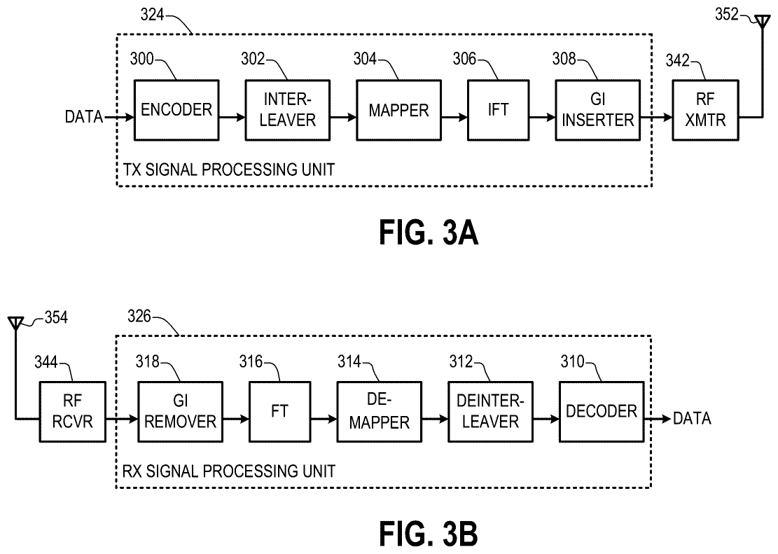

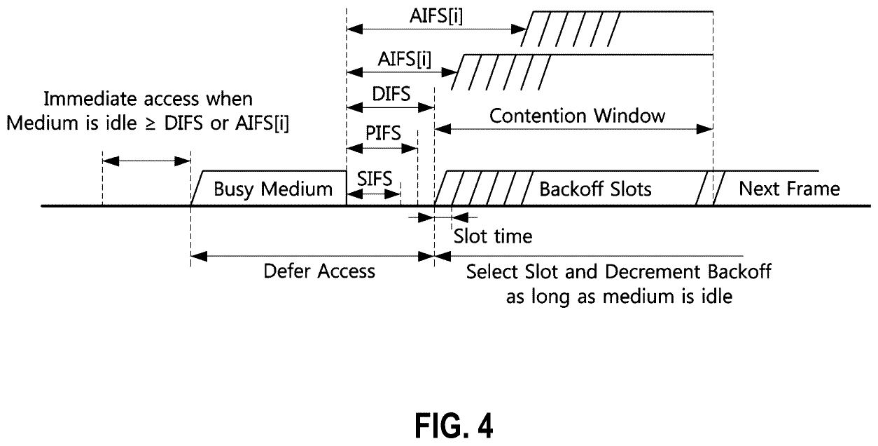

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of 0s or 1s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) (also referred to as PLCP (Physical Layer Convergence Procedure) Protocol Data Units) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

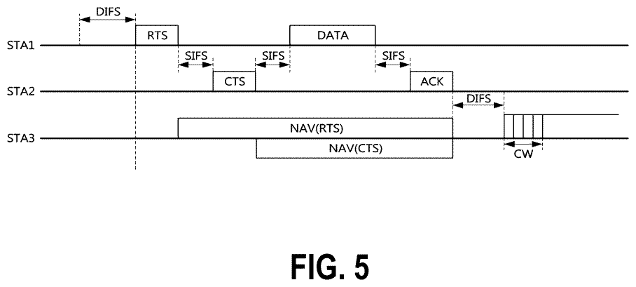

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS [i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QOS) functionality (that is, a QOS STA) may transmit the frame after performing backoff if an AIFS for an associated access category (AC) (i.e., AIFS [AC]) has elapsed. When transmitted by the QoS STA, any of the data frame, the management frame, and the control frame, which is not the response frame, may use the AIFS [AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

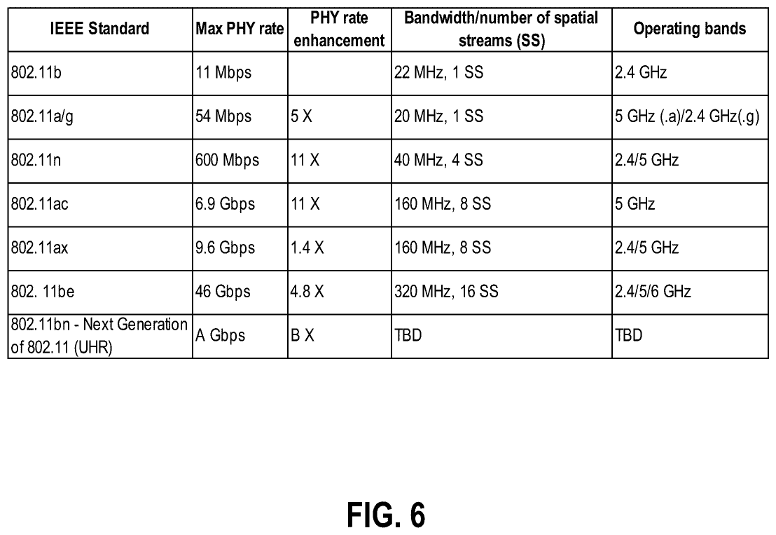

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

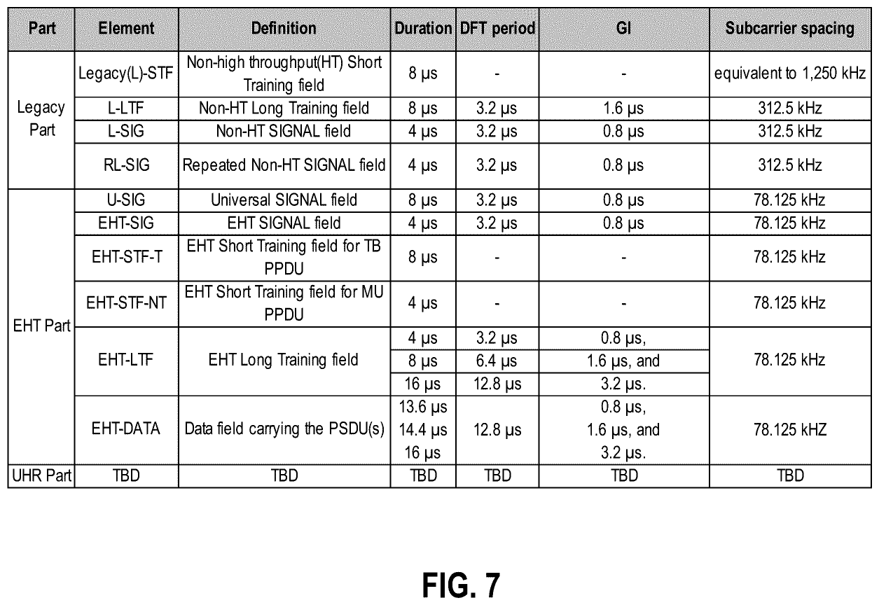

The IEEE 802.11bn (Ultra High Reliability, UHR) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR. It is noted that various characteristics of UHR (e.g., max PHY rate, PHY rate enhancement, bandwidth/number of spatial streams, and operating bands) are still to be determined.

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

The focus of IEEE 802.11bn (UHR) is still under discussion, with candidate features including MLO enhancements (e.g., in terms of increased throughput/reliability and decreased latency), latency and reliability improvements (e.g., multi-AP coordination to support low latency traffic), bandwidth expansion (e.g., to 240, 480, 640 MHZ), aggregated PPDU (A-PPDU), enhanced multi-link single-radio (cMLSR) extensions to AP, roaming improvements, and power-saving schemes for prolonging battery life.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHZ) for IEEE 802.11be, more than 1 GHz of additional unlicensed spectrum is likely to be available because the 6 GHz band (5.925-7.125 GHZ) is being considered for unlicensed use. This would allow APs and STAs to become tri-band devices. Larger than 160 MHz data transmissions (e.g., 320 MHz or 640 MHZ) could be considered to increase the maximum PHY rate. For example, 320 MHZ or 160+160 MHz data could be transmitted in the 6 GHz band. For example, 160+160 MHz data could be transmitted across the 5 and 6 GHz bands.

In the process of wireless communication, a transmitting station (STA) creates a Physical Layer Protocol Data Unit (PPDU) frame and sends it to a receiving STA. The receiving STA then receives, detects, and processes the PPDU.

The Extremely High Throughput (EHT) PPDU frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

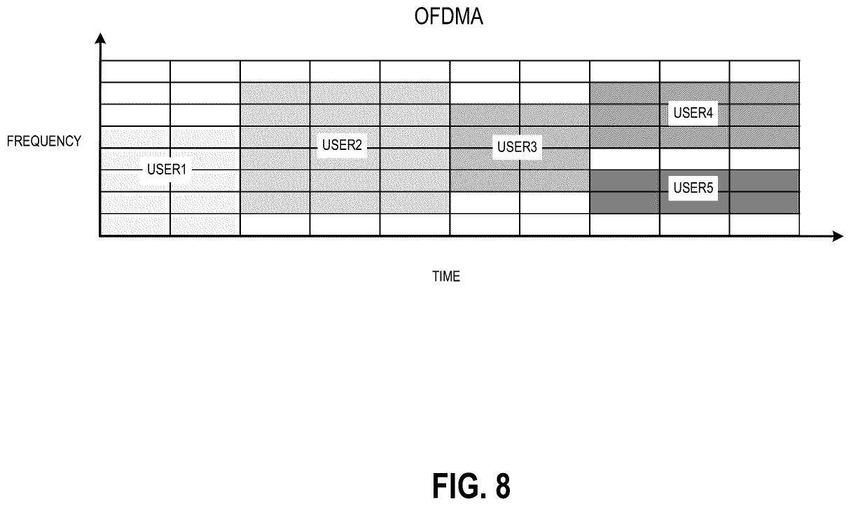

FIG. 7 provides a more detailed description of each field in the EHT PPDU frame, including their purposes and characteristics.

Regarding the Ultra High Reliability (UHR) PPDU, its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANs, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a basic service set (BSS), such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision-free operation.

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission and different spatial streams in Multi-User Multiple Input Multiple Output (MU-MIMO) transmission. Consequently, downlink OFDMA (DL-OFDMA), downlink MU-MIMO (DL-MU-MIMO), uplink OFDMA (UL-OFDMA), uplink MU-MIMO (UL-MU-MIMO), and OFDMA with MU-MIMO are all considered examples of MU transmission.

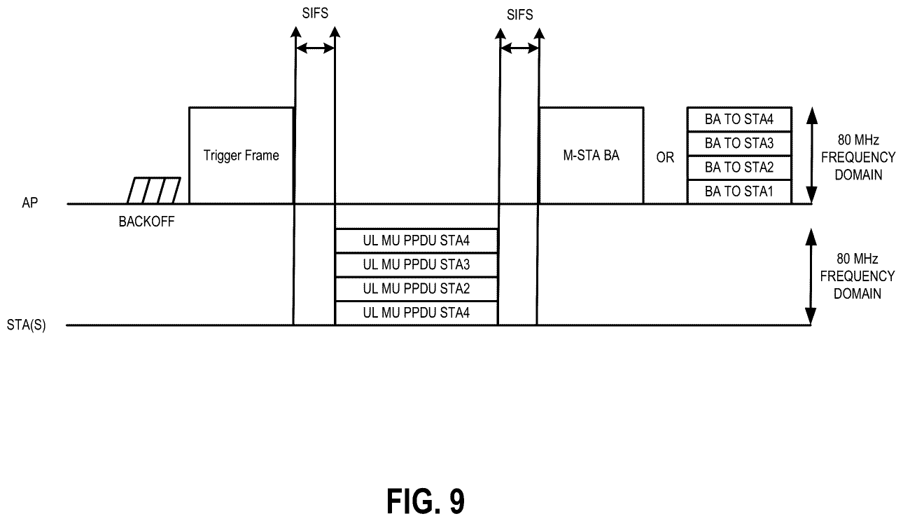

FIG. 8 illustrates an example of multi-user (MU) transmission in Orthogonal Frequency-Division Multiple Access (OFDMA), in accordance with some embodiments of the present disclosure.

In the IEEE 802.11ax and 802.11be specifications, the trigger frame plays a useful role in facilitating uplink multi-user (MU) transmissions. The purpose of the trigger frame is to allocate resources and solicit one or more Trigger-based (TB) Physical Layer Protocol Data Unit (PPDU) transmissions from the associated stations (STAs).

The trigger frame contains information required by the responding STAs to send their Uplink TB PPDUs. This information includes the Trigger type, which specifies the type of TB PPDU expected, and the Uplink Length (UL Length), which indicates the duration of the uplink transmission.

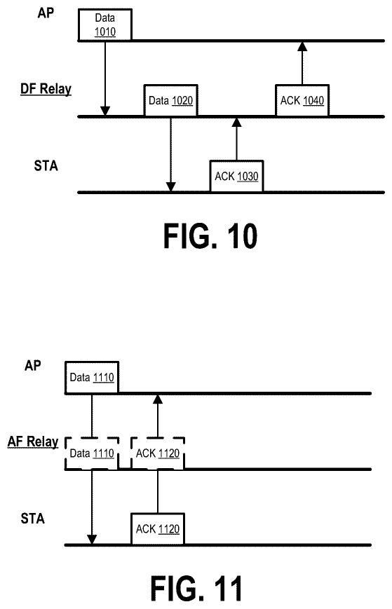

FIG. 9 illustrates an example scenario where an access point (AP) operating in an 80 MHz bandwidth environment sends a Trigger frame to multiple associated STAs. Upon receiving the Trigger frame, the STAs respond by sending their respective Uplink Orthogonal Frequency Division Multiple Access (UL OFDMA) TB PPDUs, utilizing the allocated resources within the specified 80 MHz bandwidth.

After successfully receiving the UL OFDMA TB PPDUs, the AP acknowledges the STAs by sending an acknowledgement frame. This acknowledgement can be in the form of an 80 MHz width multi-STA Block Acknowledgement (Block Ack) or a Block Acknowledgement with a Direct Feedback (DF) OFDMA method. The multi-STA Block Ack allows the AP to acknowledge multiple STAs simultaneously, while the Block Ack with DF OFDMA enables the AP to provide feedback to the STAs using the same OFDMA technique employed in the uplink transmission.

The trigger frame is a useful component in enabling efficient uplink MU transmissions in IEEE 802.11ax and 802.11be networks, by allocating resources and coordinating the uplink transmissions from multiple STAs within the same bandwidth.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

AP coordination has been considered as a potential technology to improve WLAN system throughput in the IEEE 802.11be standard and is still being discussed in the IEEE 802.11bn (UHR) standard. To support various AP coordination schemes, such as coordinated beamforming, OFDMA, TDMA, spatial reuse, and joint transmission, a predefined mechanism for APs is necessary.

In the context of coordinated TDMA (C-TDMA), the AP that obtains a transmit opportunity (TXOP) is referred to as the sharing AP. This AP initiates the AP coordination schemes to determine the AP candidate set by sending a frame, such as a Beacon frame or probe response frame, which includes information about the AP coordination scheme capabilities. The AP that participates in the AP coordination schemes after receiving the frame from the sharing AP is called the shared AP. The sharing AP is also known as the master AP or coordinating AP, while the shared AP is referred to as the slave AP or coordinated AP.

The operation of various AP coordination schemes has been discussed in the IEEE 802.11be and UHR standards:

Coordinated Beamforming (C-BF): Multiple APs transmit on the same frequency resource by coordinating and forming spatial nulls, allowing for simultaneous transmission from multiple APs.

Coordinated OFDMA (C-OFDMA): APs transmit on orthogonal frequency resources by coordinating and splitting the spectrum, enabling more efficient spectrum utilization.

Joint Transmission (JTX): Multiple APs transmit jointly to a given user simultaneously by sharing data between the APs.

Coordinated Spatial Reuse (C-SR): Multiple APs or STAs adjust their transmit power to reduce interference between APs.

By implementing these AP coordination schemes, WLAN systems can improve their overall throughput and efficiency by leveraging the cooperation between multiple APs.

The use of relay communication can increase the flexibility of wireless network deployments. Relay communication is one of the technologies that is being considered for use in future wireless networking standards (e.g., IEEE 802.11 UHR (IEEE 802.11bn)) to help improve rate-vs-range throughput. For example, by using relay communication, a first wireless device that is outside of the communication range of a second wireless device can communicate with the second wireless device via a relay device. Also, using relay communication can boost the signal-to-noise ratio (SNR), which can help improve throughput. There are two types of relay mechanisms: one is the decode-and-forward (DF) relay mechanism and the other is the amplify-and-forward (AF) relay mechanism.

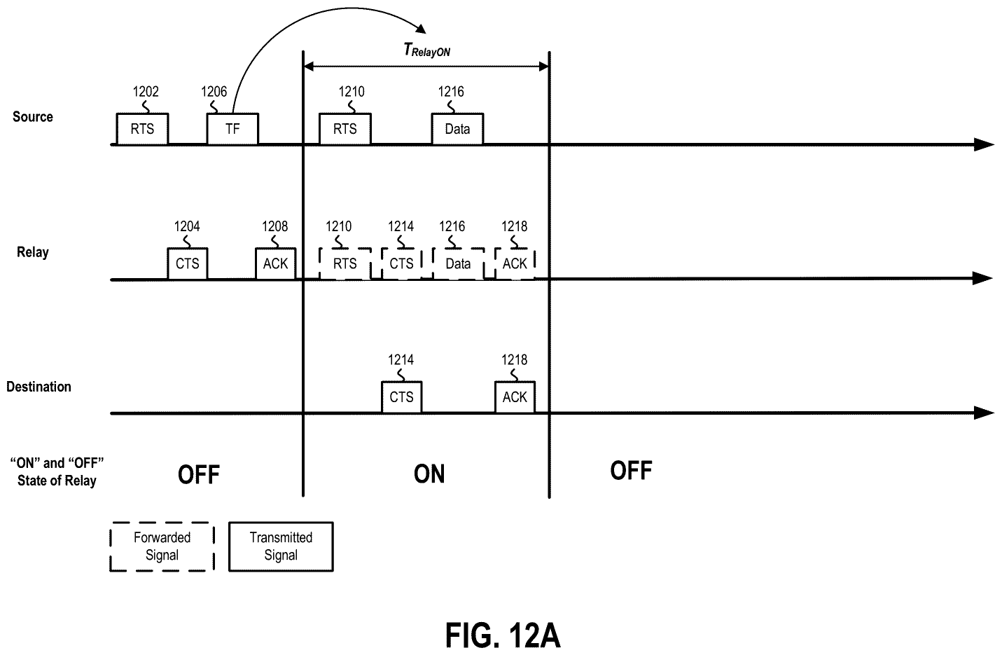

FIG. 10 is a diagram showing an example of data being relayed using a DF relay mechanism, according to some embodiments.

As shown in the diagram, an AP may transmit data frame 1010 that is to be relayed to a STA by a DF relay node. The DF relay node may receive data frame 1010 that was transmitted by the AP and decode it. After decoding data frame 1010, the DF relay node may reencode data frame 1010 as relay data frame 1020 and transmit relay data frame 1020 to the STA. If the STA successfully receives relay data frame 1020, it may respond by transmitting acknowledgement (ACK) frame 1030. The DF relay node may receive ACK frame 1030 that was transmitted by the STA and decode it. After decoding ACK frame 1030, the STA may reencode ACK frame 1030 as relay ACK frame 1040 and transmit relay ACK frame 1040 to the AP.

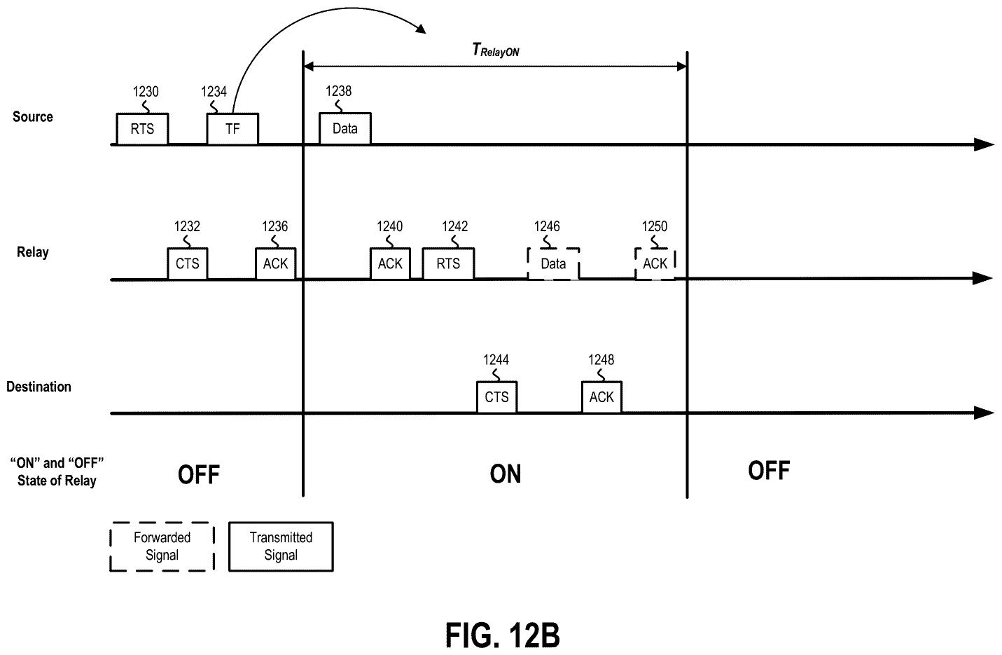

FIG. 11 is a diagram showing an example of data being relayed using an AF relay mechanism, according to some embodiments.

As shown in the diagram, an AP may transmit data frame 1110 that is to be relayed to a STA by an AF relay node. The AF relay node may amplify and forward data frame 1110 to the STA (as represented in the diagram by the AF relay node transmitting data frame 1110 in dashed lines). If the STA successfully receives the amplified and forwarded data frame 1110, it may respond by transmitting an ACK frame 1120. The AF relay node may amplify and forward ACK frame 1120 to the AP (as represented in the diagram by the AF relay node transmitting ACK frame 1120 in dashed lines). The AF relay mechanism has at least the following benefits compared to the DF relay mechanism: lower computation cost (e.g., because there is no need to fully decode received frames) and lower latency for data exchange.

Techniques are described herein for turning on and turning off relay functionality of a relay node in a wireless network. The techniques may be applicable to AF relay nodes (relay nodes that use an AF relay mechanism) and DF relay nodes (relay nodes that use a DF relay mechanism). Relay functionality that is turned on may also be referred to as being activated or similar terminology. A relay node that has its relay functionality turned on may be referred to as being in an “ON” state. Relay functionality that is turned off may also be referred to as being deactivated or similar terminology. A relay node that has its relay functionality turned off may be referred to as being in an “OFF” state. A relay node that has its relay functionality turned on is capable of relaying data. A relay node that has its relay functionality turned off is not capable of relaying data.

To prevent the problem of a relay node amplifying and forwarding unexpected noise and interference signals when there is no data to be relayed to a destination node, a relay node may keep its relay functionality turned off by default, and only turn on its relay functionality when it receives a frame indicating that its relay functionality should be turned on. The relay node may relay communications between a source node and a destination node when the relay functionality of the relay node is turned on. Various ways to indicate that the relay node should turn on or turn off its relay functionality will be described later herein.

To be able to control the relay functionality of a relay node, the relay node may include a non-AP STA entity that can communicate with other STAs (e.g., AP). Having a non-AP STA entity may allow the relay node to receive frames from other APs/STAs indicating whether relay functionality of the relay node should be turned on or turned off. The relay node may also include a relay entity that relays signals when its relay functionality is turned on. The relay entity does not relay signals when its relay functionality is turned off. For example, if the non-AP STA entity receives a frame indicating that relay functionality of the relay node should be turned on while the relay entity is turned off or inactive (and thus functionality of the relay node is turned off), the relay node may turn on or activate the relay entity (so that relay functionality of the relay node is turned on).

### “ON” and “OFF” Indication Methods

A source node may transmit a frame to a relay node to indicate whether relay functionality of the relay node should be turned on or turned off (i.e., to control relay functionality of the relay node). The transmission of this frame may be protected by a RTS frame and CTS frame exchange.

Several ways to indicate that relay functionality of a relay node should be turned on (or tuned off) are described herein below.

Method 1. Trigger Frame or New Control Frame can Indicate that a Relay Node should Turn on or Turn Off its Relay Functionality

In an embodiment (referred to herein as “Method 1”), a trigger frame that is not a MU RTS frame is extended or a new type of control frame is defined to indicate whether relay functionality of a relay node should be turned on or turned off. Various examples will be described herein where a trigger frame is used for controlling relay functionality of a relay node. It should be appreciated, however, that other types of control frames can be used. The transmission of the trigger frame may be protected using a RTS frame and CTS frame exchange, and the transmitter of the control frame can know that the relay node successfully received the control frame if the transmitter receives an ACK frame from the relay node. Various ways to control relay functionality of a relay node using a trigger frame are described herein below.

### Method 1 Alt 1

In a first embodiment (referred to herein as “Method 1 Alt 1”), the trigger frame includes a “relay on time duration indicator” that indicates the time duration of a time period during which relay functionality of the relay node should be turned on. For example, the trigger frame may include a new field that specifies a value that indicates the time duration. A source node may transmit such trigger frame to the relay node to indicate that the relay node should turn on relay functionality for the indicated time duration. The relay node may turn on its relay functionality for the indicated duration immediately after receiving the trigger frame or immediately after transmitting a response frame (e.g., ACK frame) to the source node. The relay node may relay any frames during the indicated duration. If before the time duration expires, the relay node receives a subsequent trigger frame that includes a relay on time duration indicator that indicates a time duration of zero, the relay node may turn off its relay functionality immediately after receiving such trigger frame or immediately after transmitting a response frame (e.g., ACK frame) to the source node (e.g., if the trigger frame requires an immediate response).

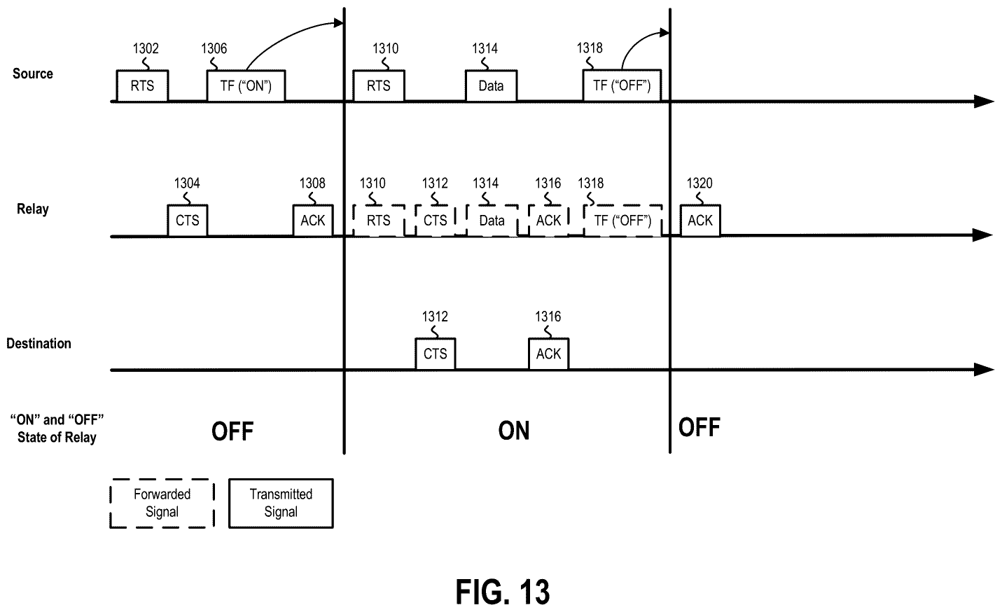

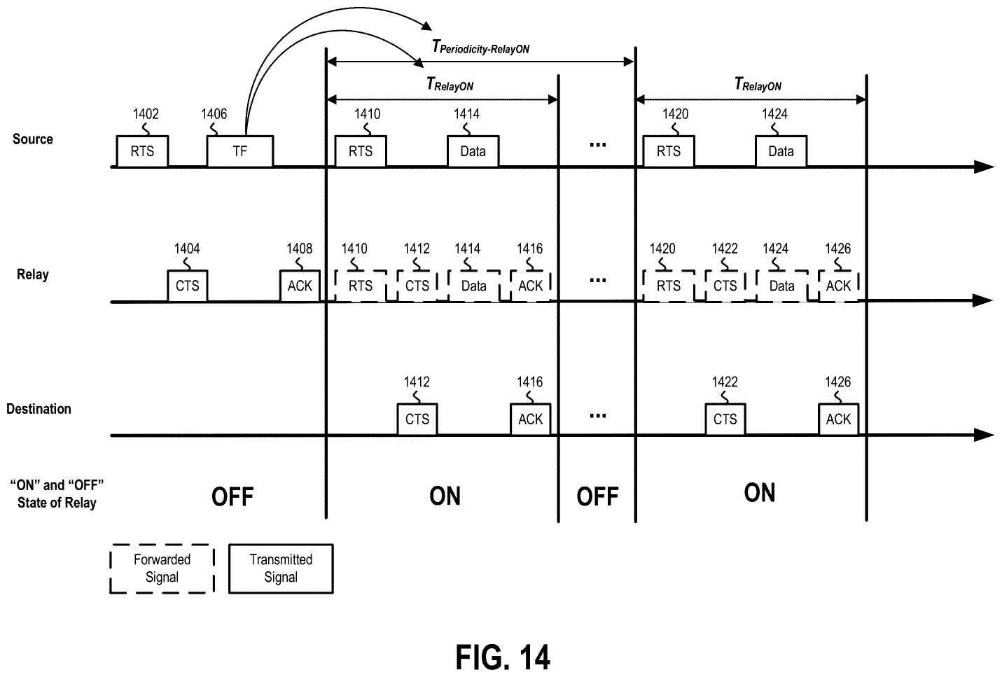

FIG. 12A is a diagram showing the use of a trigger frame that includes a relay on time duration indicator to turn on relay functionality of an AF relay node, according to some embodiments.

As shown in the diagram, the source node may transmit RTS frame 1202 to the relay node and the relay node may respond by transmitting CTS frame 1204 to the source node. The RTS frame 1202 and CTS frame 1204 exchange may help protect the upcoming transmission of trigger frame 1206. The source node may then transmit trigger frame 1206 (“TF”) to the relay node. The trigger frame may include a relay on time duration indicator that indicates a time duration of a time period during which relay functionality of the relay node should be turned on. Responsive to receiving trigger frame 1206, the relay node may transmit ACK frame 1208 to the relay node to acknowledge successful reception of trigger frame 1206. The relay node may turn on its relay functionality after transmitting ACK frame 1208. In this example, it is assumed that the relay node is an AF relay node (it uses an AF relay mechanism to relay data). Also, it is assumed that trigger frame 1206 requires an immediate response (in the form of ACK frame 1208). The relay node may keep its relay functionality turned on for the time duration indicated in trigger frame 1206. The time duration for which the relay node should keep its relay functionality turned on may be referred to as T_RelayON (“T_{RelayON}”). During T_RelayON, the source node may transmit RTS frame 1210 and the relay node may relay RTS frame 1210 to the destination node. Responsive to receiving RTS frame 1210, the destination node may transmit CTS frame 1214 and the relay node may relay CTS frame 1214 to the source node. The RTS frame 1210 and CTS frame 1214 exchange may help protect the upcoming transmission of data frame 1216. Also, during T_RelayON, the source node may transmit data frame 1216 and the relay node may relay data frame 1216 to the destination node. Responsive to receiving data frame 1216, the destination node may transmit ACK frame 1218 to acknowledge successful reception of data frame 1216, and the relay node may relay ACK frame 1218 to the source node. The relay node may turn off its relay functionality after T_RelayON expires.

FIG. 12B is a diagram showing the use of a trigger frame that includes a relay on time duration indicator to turn on relay functionality of an DF relay node, according to some embodiments.

As shown in the diagram, the source node may transmit RTS frame 1230 to the relay node and the relay node may respond by transmitting CTS frame 1232 to the source node. The RTS frame 1230 and CTS frame 1232 exchange may help protect the upcoming transmission of trigger frame 1234. The source node may then transmit trigger frame 1234 (“TF”) to the relay node. The trigger frame may include a relay on time duration indicator that indicates a time duration of a time period during which relay functionality of the relay node should be turned on (i.e., indicate T_RelayON). Responsive to receiving trigger frame 1234, the relay node may transmit ACK frame 1236 to the relay node to acknowledge successful reception of trigger frame 1234. The relay node may turn on its relay functionality after transmitting ACK frame 1236. In this example, it is assumed that the relay node is a DF relay node (it uses a DF relay mechanism to relay data). Also, it is assumed that trigger frame 1234 requires an immediate response (in the form of ACK frame 1236). The relay node may keep its relay functionality turned on for T_RelayON indicated in trigger frame 1234. During T_RelayON, the source node may transmit data frame 1238 to the relay node. Responsive receiving data frame 1238, the relay node may transmit ACK frame 1240 to the source node to acknowledge successful reception of data frame 1238. Also, during T_RelayON, The relay node may transmit RTS frame 1242 to the destination node and the destination node may respond by transmitting CTS frame 1244 to the relay node. The RTS frame 1242 and CTS frame 1244 exchange may help protect the upcoming transmission of relay data frame 1246. Also, during T_RelayON, the relay node may transmit relay data frame 1246 to the destination node. Relay data frame 1246 may include the same data that was included in data frame 1238 and decoded therefrom. Responsive to receiving relay data frame 1246, the destination node may transmit ACK frame 1248 to the relay node to acknowledge successful reception of relay data frame 1246. The relay node may transmit relay ACK frame 1250 to the source node to indicate that data frame 1238 was successfully relayed to the destination node. The relay node may turn off its relay functionality after T_RelayON expires.

In a second embodiment (referred to herein as “Method 1 Alt 2”), the trigger frame includes a “relay on/off indicator” that indicates that the relay node should turn on its relay functionality. For example, the trigger frame may include a new field that specifies a value (e.g., a bit value of ‘1’) that indicates that the relay node should turn on its relay functionality. A source node may transmit such trigger frame to the relay node to indicate that the relay node should turn on relay functionality. The relay node may turn on its relay functionality immediately after receiving such trigger frame or immediately after transmitting a response frame to the source node (e.g., if the trigger frame requires an immediate response). The relay node may relay any frames while its relay functionality is turned on.

In an embodiment (referred to herein as “Method 1 Alt 2-1”), while a relay node has its relay functionality turned on, the source node may transmit a trigger frame to the relay node that includes a relay on/off indicator that indicates that the relay node should turn off its relay functionality (e.g., the trigger frame may include the new field mentioned above specifying a bit value of ‘0’ to indicate that the relay node should turn off its relay functionality). The relay node may turn off its relay functionality in response to receiving such trigger frame.

In an embodiment (referred to herein as “Method 1 Alt 2-2”), the relay node turns off its relay functionality after its relay functionality has been turned on for a predefined time duration (e.g., which can be defined in a wireless networking standard) or a prespecified time duration (which may be referred to as an “expired relay on time duration”). The expired relay on time duration may have been prespecified in a frame that the relay node received before receiving the trigger frame or through other means.

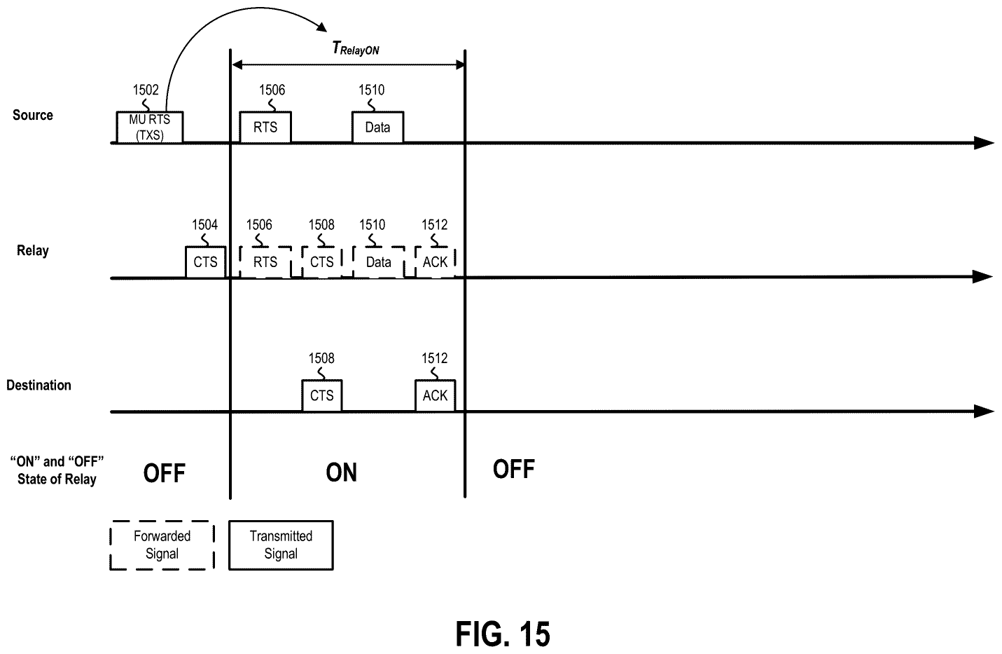

FIG. 13 is a diagram showing the use of a trigger frame that includes a relay on/off indicator to turn on relay functionality, according to some embodiments. The example shown in the diagram exemplifies Method Alt 2-1 mentioned above.

As shown in the diagram, the source node may transmit RTS frame 1302 to the relay node and the relay node may respond by transmitting CTS frame 1304 to the source node. The RTS frame 1302 and CTS frame 1304 exchange may help protect the upcoming transmission of trigger frame 1306. The source node may then transmit trigger frame 1306 (“TF”) to the relay node. Trigger frame 1306 may include a relay on/off indicator that indicates that the relay node should turn on its relay functionality. Responsive to receiving trigger frame 1306, the relay node may transmit ACK frame 1308 to the relay node to acknowledge successful reception of trigger frame 1306. The relay node may turn on its relay functionality after transmitting ACK frame 1308. In this example, it is assumed that the relay node is an AF relay node (it uses an AF relay mechanism to relay data). Also, it is assumed that trigger frame 1306 requires an immediate response (in the form of ACK frame 1308). The relay node may keep its relay functionality turned on until it receives a subsequent trigger frame that includes a relay on/off indicator that indicates that the relay node should turn off its relay functionality. While the relay node has its relay functionality turned on, the source node may transmit RTS frame 1310 and the relay node may relay RTS frame 1310 to the destination node. Responsive to receiving RTS frame 1310, the destination node may transmit CTS frame 1312 and the relay node may relay CTS frame 1312 to the source node. The RTS frame 1310 and CTS frame 1312 exchange may help protect the upcoming transmission of data frame 1314. While the relay node has its relay functionality turned on, the source node may transmit data frame 1314 and the relay node may relay data frame 1314 to the destination node. Responsive to receiving data frame 1314, the destination node may transmit ACK frame 1316 to acknowledge successful reception of data frame 1314, and the relay node may relay ACK frame 1316 to the source node. The source node may then transmit trigger frame 1318 to the relay node. Trigger frame 1318 may include a relay on/off indicator that indicates that the relay node should turn off its relay functionality. The transmission of trigger frame 1318 may be protected by the RTS frame 1310 and CTS frame 1320 exchange or an additional RTS frame and CTS frame exchange, if needed. Responsive to receiving trigger frame 1318, the relay node may turn off its relay functionality and transmit ACK frame 1320 to the relay node to acknowledge successful reception of trigger frame 1318.

In a third embodiment (referred to herein as “Method 1 Alt 3”), the trigger frame includes a “relay on time duration indicator” that indicates a time duration of each recurring time period during which relay functionality of the relay node should be turned on and a “periodicity of relay on time duration indicator” that indicates a periodicity of the recurring time periods. For example, the trigger frame may include a first new field that specifies a value that indicates the time duration of each recurring time period and a second new field that specifies a value that indicates the periodicity of the recurring time periods. The periodicity may be expressed as a time duration between the start of one time period and the start of the next time period. In such case, the periodicity should be equal or greater than the time duration of a single time period when the periodicity is a non-zero value. When the periodicity is a zero value, Alt 3 may operate the same as Alt 1 described above. A source node may transmit such trigger frame to the relay node to indicate that the relay node should periodically turn on its relay functionality for the indicated time duration in accordance with the indicated periodicity. The relay node may turn on its relay functionality for the indicated duration immediately after receiving the trigger frame or immediately after transmitting a response frame to the source node (e.g., if the trigger frame requires an immediate response). The relay node may then periodically turn on its relay functionality for the indicated time duration in accordance with the indicated periodicity. The relay node may relay any frames when its relay functionality is turned on. If the relay node receives a subsequent trigger frame that includes a relay on time duration indicator that indicates a time duration of zero, the relay node may turn off its periodic relay functionality immediately after receiving such trigger frame or immediately after transmitting a response frame to the source node (e.g., if the trigger frame requires an immediate response).

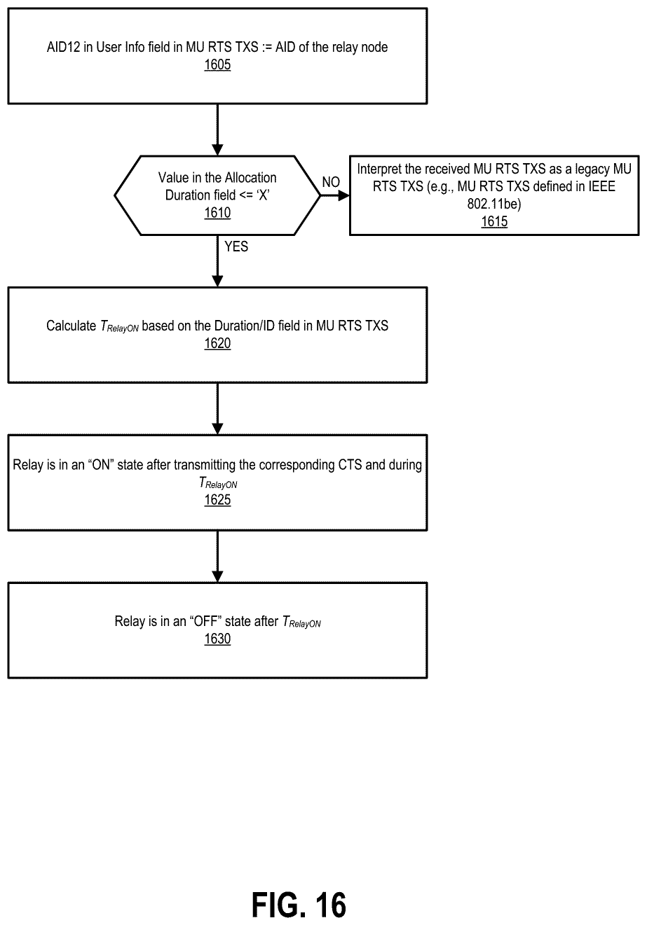

FIG. 14 is a diagram showing the use of a trigger frame that includes a relay on time duration indicator and a periodicity of relay on time duration indicator to turn on relay functionality of an AF relay node, according to some embodiments.

As shown in the diagram, the source node may transmit RTS frame 1402 to the relay node and the relay node may respond by transmitting CTS frame 1404 to the source node. The RTS frame 1402 and CTS frame 1404 exchange may help protect the upcoming transmission of trigger frame 1406. The source node may then transmit trigger frame 1406 (“TF”) to the relay node. The trigger frame may include a relay on time duration indicator that indicates a time duration of each recurring time period during which relay functionality of the relay node should be turned on (“T_RelayON”) and a periodicity of relay on time duration indicator that indicates a periodicity of the recurring time periods (“T_Periodicity-RelayON” or “T_{Periodicity-RelayON}”). Responsive to receiving trigger frame 1406, the relay node may transmit ACK frame 1408 to the relay node to acknowledge successful reception of trigger frame 1406. The relay node may turn on its relay functionality after transmitting ACK frame 1408 to start a first time period during which its relay functionality is turned on. During the first time period, the source node may transmit RTS frame 1410 and the relay node may relay RTS frame 1410 to the destination node. Responsive to receiving RTS frame 1410, the destination node may transmit CTS frame 1412 and the relay node may relay CTS frame 1412 to the source node. The RTS frame 1410 and CTS frame 1412 exchange may help protect the upcoming transmission of data frame 1414. Also, during the first time period, the source node may transmit data frame 1414 and the relay node may relay data frame 1414 to the destination node. Responsive to receiving data frame 1414, the destination node may transmit ACK frame 1416 to acknowledge successful reception of data frame 1414, and the relay node may relay ACK frame 1416 to the source node. The relay node may turn off its relay functionality after T_RelayON expires (after relay functionality has been turned on for T_RelayON), thereby ending the first time period. In this example, it is assumed that the relay node is an AF relay node (it uses an AF relay mechanism to relay data). Also, it is assumed that trigger frame 1406 requires an immediate response (in the form of ACK frame 1408).

The relay node may periodically turn on its relay functionality for the indicated time duration in accordance with the indicated periodicity. The periodicity may be expressed as a time duration between the start of consecutive recurring time periods. The relay node may turn on its relay functionality again after T_Periodicity-RelayON to start a second time period during which relay functionality of the relay node is turned on. During the second time period, the source node may transmit RTS frame 1420 and the relay node may relay RTS frame 1420 to the destination node. Responsive to receiving RTS frame 1420, the destination node may transmit CTS frame 1422 and the relay node may relay CTS frame 1422 to the source node. The RTS frame 1420 and CTS frame 1422 exchange may help protect the upcoming transmission of data frame 1424. Also, during the second time period, the source node may transmit data frame 1424 and the relay node may relay data frame 1424 to the destination node. Responsive to receiving data frame 1424, the destination node may transmit ACK frame 1426 to acknowledge successful reception of data frame 1424, and the relay node may relay ACK frame 1426 to the source node. The relay node may turn off its relay functionality after T_RelayON expires (after relay functionality has been turned on for T_RelayON), thereby ending the second time period. The relay node may continue to periodically turn on its relay functionality in this manner.

Method 1 Alt 1 only requires a single trigger frame to indicate when relay functionality should be turned on and turned off, whereas Method 1 Alt 2 (and specifically Method 1 Alt 2-1) requires two trigger frames to indicate when relay functionality should be turned on and turn off. Method 1 Alt 2 requires less bits in the trigger frame to indicate when relay functionality should be turned on or turned off compared to Method 1 Alt 1. Method 1 Alt 2 may only need a single bit to indicate whether relay functionality should be turned on or off, whereas Method 1 Alt 1 may need more than one bit to indicate the time duration. Method 1 Alt 3 requires less overhead compared to Method 1 Alt 1 and Method 1 Alt 2 to indicate when relay functionality should be turned on or off when the source node frequently or periodically transmits frames that need to be relayed (e.g., management frames). Also, Method 1 Alt 3 may be useful when a STA controls the relay node but the other non-AP STA that is in the coverage area of the relay node would transmit data to the STA that controls the relay node.

While the diagrams show certain types of frames being transmitted while relay functionality of the relay node is turned on (e.g., RTS frames, CTS frames, data frames, and ACK frames), it should be appreciated that other types of frames can be transmitted. Also, while some of the diagrams show a case where the relay node is an AF relay node, it should be appreciated that the relay node may be a DF relay node in some embodiments (e.g., similar to what is shown in FIG. 12B). Accordingly, the diagrams should be regarded as examples of particular embodiments and not regarded as limiting.

Method 2. MU RTS Frame or MU RTS TXS Frame can Indicate that a Relay Node should Turn on or Turn Off its Relay Functionality

In an embodiment (referred to herein as “Method 2”), a MU RTS frame or MU RTS TXS frame is extended or reused/repurposed to indicate whether relay functionality of a relay node should be turned on or turned off.

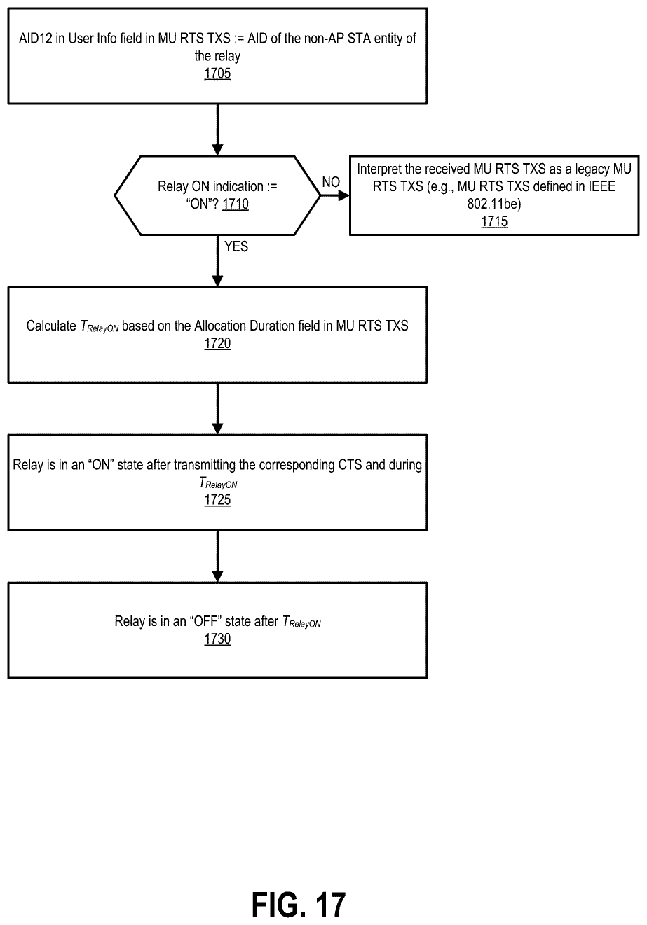

FIG. 15 is a diagram showing the use of a MU RTS frame or MU RTS TXS frame to turn on relay functionality of an AF relay node, according to some embodiments.

As shown in the diagram, the source node may transmit MU RTS (TXS) frame 1502 to the relay node. The MU RTS (TXS) frame 1502 may include a relay on time duration indicator that indicates a time duration of a time period during which relay functionality of the relay node should be turned on. Responsive to receiving MU RTS (TXS) frame 1502, the relay node may transmit CTS frame 1504 to the source node. The relay node may turn on its relay functionality after transmitting CTS frame 1504. In this example, it is assumed that the relay node is an AF relay node (it uses an AF relay mechanism to relay data). The relay node may keep its relay functionality turned on for the time duration indicated in MU RTS (TXS) frame 1502. The indicated time duration may be referred to as T_RelayON. During T_RelayON, the source node may transmit RTS frame 1506 and the relay node may relay RTS frame 1506 to the destination node. Responsive to receiving RTS frame 1506, the destination node may transmit CTS frame 1508 and the relay node may relay CTS frame 1508 to the source node. The RTS frame 1506 and CTS frame 1508 exchange may help protect the upcoming transmission of data frame 1510. Also, during T_RelayON, the source node may transmit data frame 1510 and the relay node may relay data frame 1510 to the destination node. Responsive to receiving data frame 1510, the destination node may transmit ACK frame 1512 to acknowledge successful reception of data frame 1510, and the relay node may relay ACK frame 1512 to the source node. The relay node may turn off its relay functionality after T_RelayON expires.

In contrast to Method 1, Method 2 does not require introducing additional frames (e.g., trigger frame, control frame, immediate response, etc.) to indicate that the relay node should turn on or turn off its relay functionality. Instead, Method 2 extends or reuses/repurposes the existing MU RTS frame or MU RTS TXS frame to indicate that the relay node should turn on or turn off its relay functionality. With Method 2, there is a need for a way to distinguish whether the MU RTS frame or MU RTS TXS frame is being used for controlling relay functionality or being used for legacy purposes.

While the diagram shows certain types of frames being transmitted while relay functionality of the relay node is turned on (e.g., RTS frame, CTS frame, data frame, and ACK frame), it should be appreciated that other types of frames can be transmitted. Also, while the diagrams shows a case where the relay node is an AF relay node, it should be appreciated that the relay node may be a DF relay node in some embodiments (e.g., similar to what is shown in FIG. 12B). Accordingly, the diagram should be regarded as an example of one particular embodiment and not regarded as limiting.

Various ways to control relay functionality of a relay node using a MU RTS frame or MU RTS TXS frame are described herein below.

In an embodiment (referred to herein as “Alt 1”), the Allocation Duration field included in a User Info field included in a MU RTS TXS frame can be reused to indicate that the relay node should turn on its relay functionality and the Duration/ID field included in the MU RTS TXS frame can be reused to indicate the time duration of the time period during which relay functionality should be turned on.

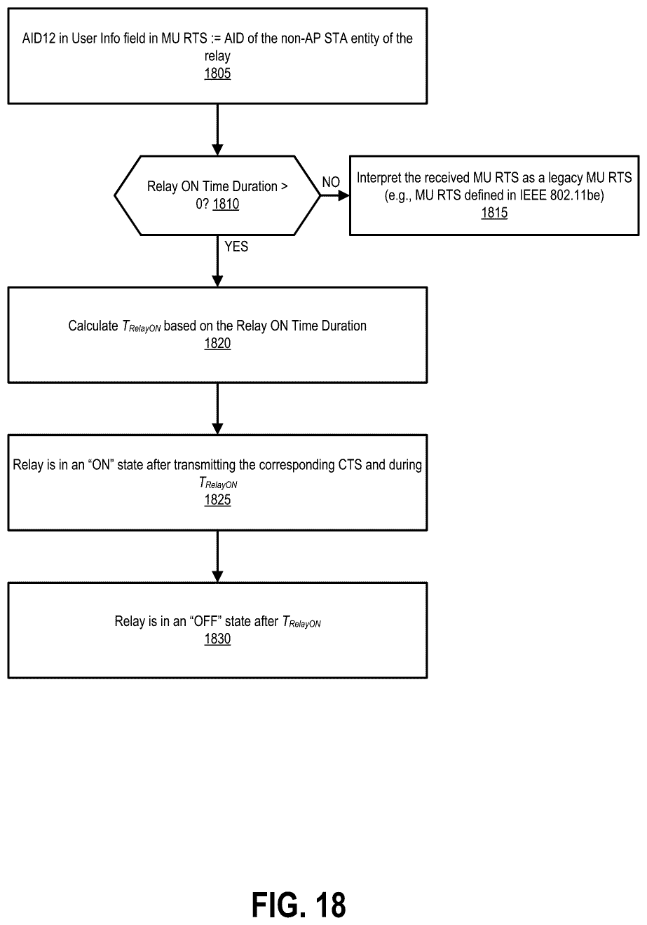

FIG. 16 is a flow diagram of a method performed by a relay node for processing a MU RTS TXS frame based on Alt 1, according to some embodiments.

As shown in the diagram, at operation 1605, the relay node determines that the AID12 (association ID) specified by the User Info field included in the MU RTS TXS frame corresponds to the AID of the relay node (e.g., the AID of the non-AP STA entity of the relay node). At operation 1610, the relay node determines whether the value specified by the Allocation Duration field is less than or equal to a predefined value (“X”). In an embodiment, “X” can be defined as the time duration between the start of the PPDU carrying the CTS frame and the end of the CTS frame plus short interframe space (SIFS), where the CTS frame is the response to the MU RTS TXS frame. In an embodiment, “X” is zero. If the value specified by the Allocation Duration field is not less than or equal to a predefined value, the relay node performs operation 1615. At operation 1615, the relay node interprets the received MU RTS TXS frame as a legacy MU RTS TXS frame (e.g., the MU RTS TXS frame defined in IEEE 802.11bc). Returning to operation 1610, if the value specified by the Allocation Duration field is less than or equal to a predefined value, the relay node performs operation 1620. At operation 1620, the relay node calculates T_RelayON based the value specified by the Duration/ID field included in the MU RTS TXS frame. For example, T_RelayON can be calculated by summing the value specified by the Duration/ID field and a predefined value (e.g., zero). At operation 1625, the relay node turns on its relay functionality after transmitting a CTS frame. The relay node keeps its relay functionality turned on for T_RelayON. At operation 1630, the relay node turns off its relay functionality after T_RelayON. In an embodiment, the relay node turns off its relay functionality early (before T_RelayON expires) if tis receives a subsequent MU RTS TXS frame that includes a Duration/ID field specifying a value that indicates a time duration of zero.

In an embodiment (referred to herein as “Alt 2”), a new field (referred to herein as a “relay on/off indication field”) is included in a MU RTS TXS frame to indicate that the relay node should turn on its relay functionality and the Allocation Duration field included in a User Info field included in the MU RTS TXS frame can be used to indicate the time duration of the time period during which relay functionality should be turned on.

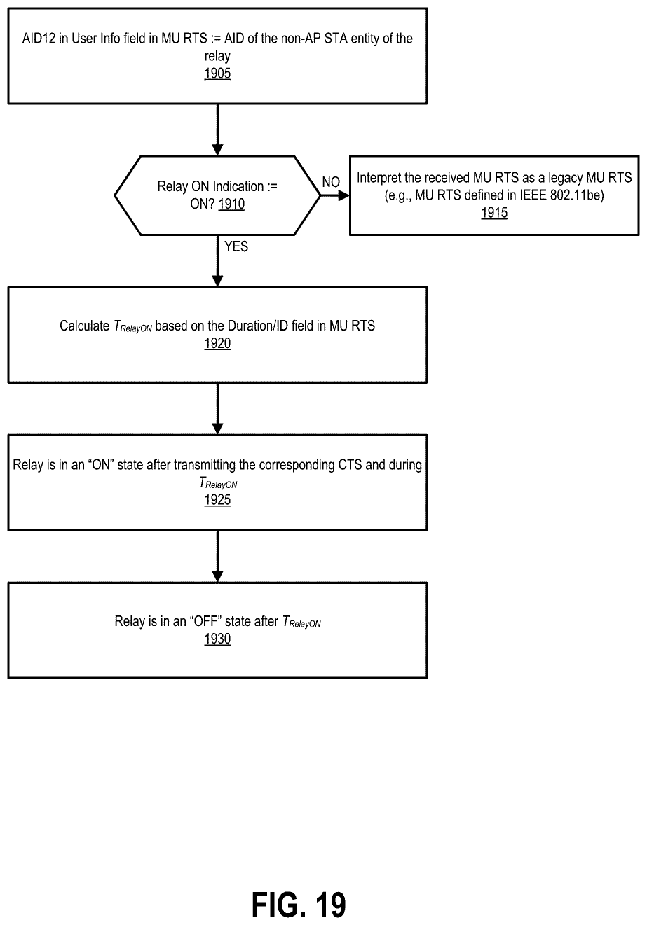

FIG. 17 is a flow diagram of a method for processing a MU RTS TXS frame based on Alt 2, according to some embodiments.

As shown in the diagram, at operation 1705, the relay node determines that the AID12 specified by the User Info field included in the MU RTS TXS frame corresponds to the AID of the relay node (e.g., the AID of the non-AP STA entity of the relay node). At operation 1710, the relay node determines whether the value specified by the relay on/off indication field indicates that relay functionality should be turned on. If the value specified by the relay on/off indication field does not indicate that relay functionality should be turned on, the relay node performs operation 1715. At operation 1715, the relay node interprets the received MU RTS TXS frame as a legacy MU RTS TXS frame (e.g., the MU RTS TXS frame defined in IEEE 802.11be). Returning to operation 1710, if the value specified by the relay on/off indication field indicates that relay functionality should be turned on, the relay node performs operation 1720. At operation 1720, the relay node calculates T_RelayON based the value specified by the Allocation Duration field included in the User Info field included in the MU RTS TXS frame. For example, T_RelayON can be calculated by summing the value specified by the Allocation Duration field and a predefined value (e.g., zero). At operation 1725, the relay node turns on its relay functionality after transmitting a CTS frame. The relay node keeps its relay functionality turned on for T_RelayON. At operation 1730, the relay node turns off its relay functionality after T_RelayON. In an embodiment, the relay node turns off its relay functionality early (before T_RelayON expires) if it receives a subsequent MU RTS TXS frame that includes an Allocation Duration field specifying a value that indicates a time duration of zero.

In an embodiment (referred to herein as “Alt 3”), a new field (referred to herein as a “relay on time duration field”) is included in a MU RTS TXS frame to indicate the time duration of the time period during which relay functionality should be turned on. The indicated time duration being a non-zero time duration may indicate that that the relay node should turn on its relay functionality.

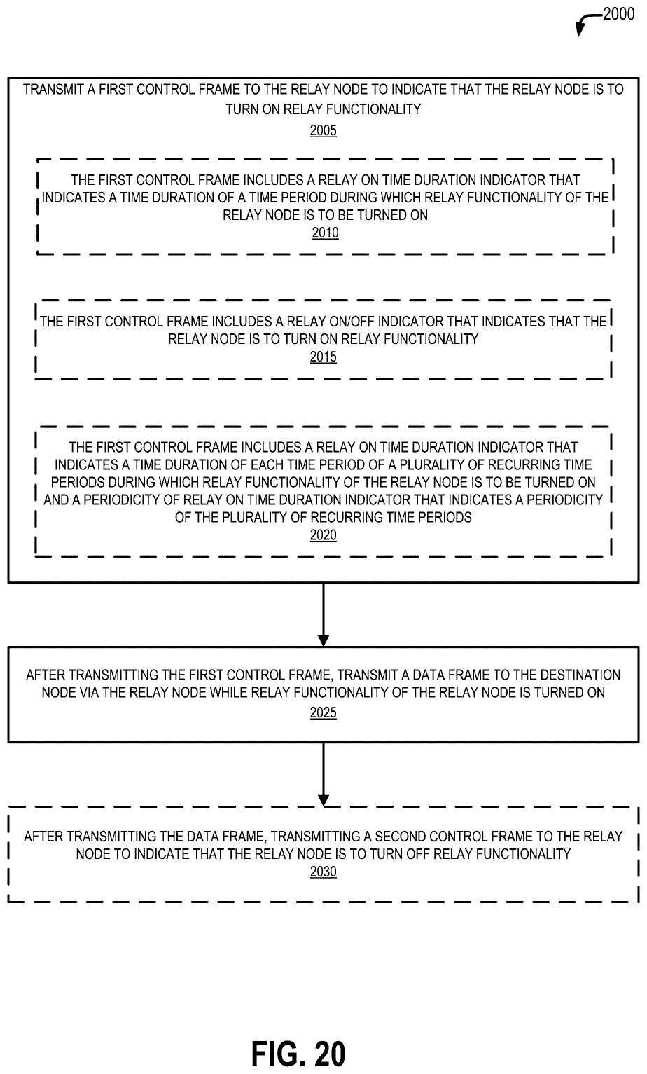

FIG. 18 is a flow diagram of a method for processing a MU RTS frame based on Alt 3, according to some embodiments.

As shown in the diagram, at operation 1805, the relay node determines that the AID12 specified by the User Info field included in the MU RTS frame corresponds to the AID of the relay node (e.g., the AID of the non-AP STA entity of the relay node). At operation 1810, the relay node determines whether the value specified by the relay on time duration field indicates a time duration that is larger than zero. If the value specified by the relay on time duration field does not indicate a time duration that is larger than zero, the relay node performs operation 1815. At operation 1815, the relay node interprets the received MU RTS frame as a legacy MU RTS frame (e.g., the MU RTS frame defined in IEEE 802.11be). Returning to operation 1810, if the value specified by the relay on time duration field indicates a time duration that is larger than zero, the relay node performs operation 1820. At operation 1820, the relay node calculates T_RelayON based the value specified by the relay on time duration field. For example, T_RelayON can be calculated by summing the value specified by the relay on time duration field and a predefined value (e.g., zero). At operation 1825, the relay node turns on its relay functionality after transmitting a CTS frame. The relay node keeps its relay functionality turned on for T_RelayON. At operation 1830, the relay node turns off its relay functionality after T_RelayON. In an embodiment, the relay node turns off its relay functionality early (before T_RelayON expires) if it receives a subsequent MU RTS frame that includes a relay on time duration field specifying a value that indicates a time duration of zero (e.g., a legacy MU RTS frame).

In an embodiment (referred to herein as “Alt 4”), a new field (referred to herein as a “relay on/off indication field”) is included in a MU RTS frame to indicate that the relay node should turn on its relay functionality and the Duration/ID field included in the MU RTS frame can be used to indicate the time duration of the time period during which relay functionality should be turned on.

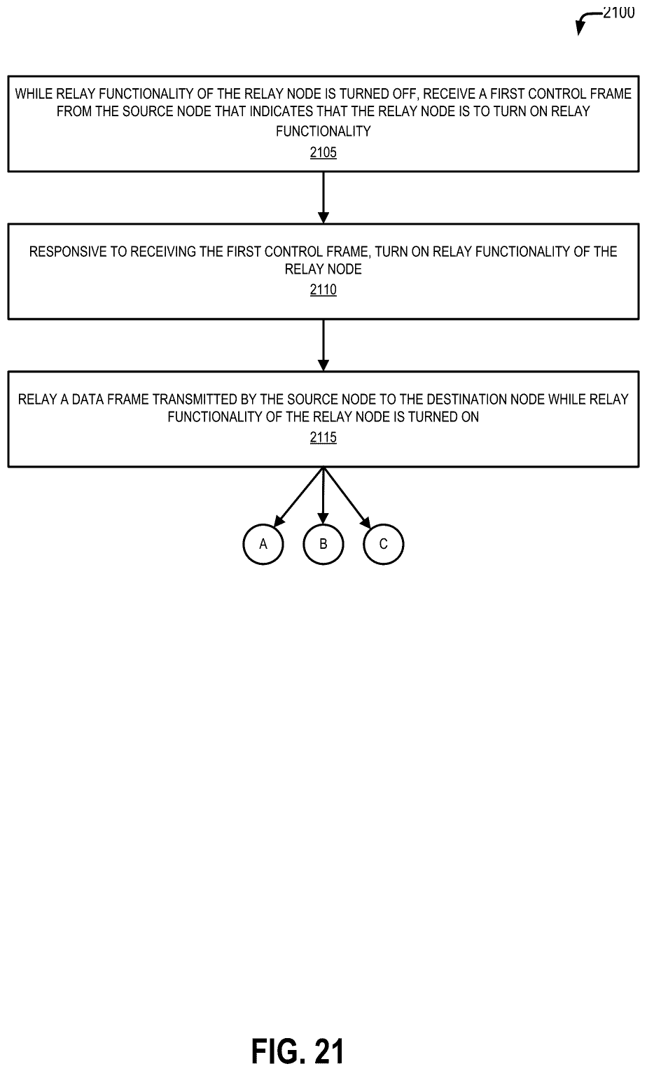

FIG. 19 is a flow diagram of a method for processing a MU RTS frame based on Alt 4, according to some embodiments.

As shown in the diagram, at operation 1905, the relay node determines that the AID12 specified by the User Info field included in the MU RTS frame corresponds to the AID of the relay node (e.g., the AID of the non-AP STA entity of the relay node). At operation 1910, the relay node determines whether the value specified by the relay on/off indication field indicates that relay functionality should be turned on. If the value specified by the relay on/off indication field does not indicate that relay functionality should be turned on, the relay node performs operation 1915. At operation 1915, the relay node interprets the received MU RTS frame as a legacy MU RTS frame (e.g., the MU RTS frame defined in IEEE 802.11bc). Returning to operation 1910, if the value specified by the relay on/off indication field indicates that relay functionality should be turned on, the relay node performs operation 1920. At operation 1920, the relay node calculates T_RelayON based the value specified by the Duration/ID field included in the MU RTS frame. For example, T_RelayON can be calculated by summing the value specified by the Duration/ID field and a predefined value (e.g., zero). At operation 1925, the relay node turns on its relay functionality after transmitting a CTS frame. The relay node keeps its relay functionality turned on for T_RelayON. At operation 1930, the relay node turns off its relay functionality after T_RelayON expires. In an embodiment, the relay node turns off its relay functionality early (before T_RelayON expires) if it receives a subsequent MU RTS frame that includes a Duration/ID field specifying a value that indicates a time duration of zero.

Method 2 Alt 1 does not change the existing MU RTS TXS frame format so it has the least impact on the wireless networking standard among Method 2 Alts 1-4. Method 2 Alt 2 requires at least one additional bit to control relay functionality of a relay node but it has less of an impact on the wireless networking standard compared to Method 2 Alt 3 and Method 2 Alt 4. Method 2 Alt 2 can be considered as an explicit way to indicate that relay functionality should be turned on or off, while Method 2 Alt 1 can be considered as an implicit way to indicate that relay functionality should be turned on or off. Method 2 Alt 3 and Method 2 Alt 4 may control relay functionality of multiple relay nodes simultaneously, whereas Method 2 Alt 1 and Method 2 Alt 2 may only control relay functionality of a single relay node. Alt 3 requires more bits than Alt 4, but it does not require changes to the wireless networking standard or implementation to set the Duration/ID field in the MU RTS frame. A combination of Method 2 Alts 1-4 and Method 1 Alt 3 1 is contemplated and within the scope of this disclosure. For example, the above-mentioned Method 2 Alts 1-4 can indicate the periodicity (T_Periodicity-RelayON)) mentioned in Alt 3 of Method 1.

In an embodiment, the techniques described herein can be applied to a roaming scenario. In a roaming scenario, a STA may roam from a source AP to a target AP. The source AP may forward downlink (DL) data intended for a (non-AP) STA to a target AP via a wireless backhaul link so that the STA can receive the DL data after it connects with the target AP. This operation can be viewed as the target AP relaying DL data transmitted by the source AP to the STA. Thus, the relay techniques described herein can be applied to such scenario, where the source node is the source AP, the relay node is the target AP, and the destination node is the STA.

The techniques described herein may provide one or more advantages. Since relay functionality of a relay node is turned off by default and only turned on when there is data to relay to a destination node, the power consumption of the relay node is reduced. Also, in the case when the relay node uses an AF relay mechanism, unexpected noise and interference is not amplified and forwarded when there is no data to be relayed. The techniques described herein can protect the transmission of relayed data, taking into consideration the hidden node problem caused by the extended transmission range of the relay node. Also, the rate-vs-range throughput in the wireless network can be increased by virtue of the relay operations.

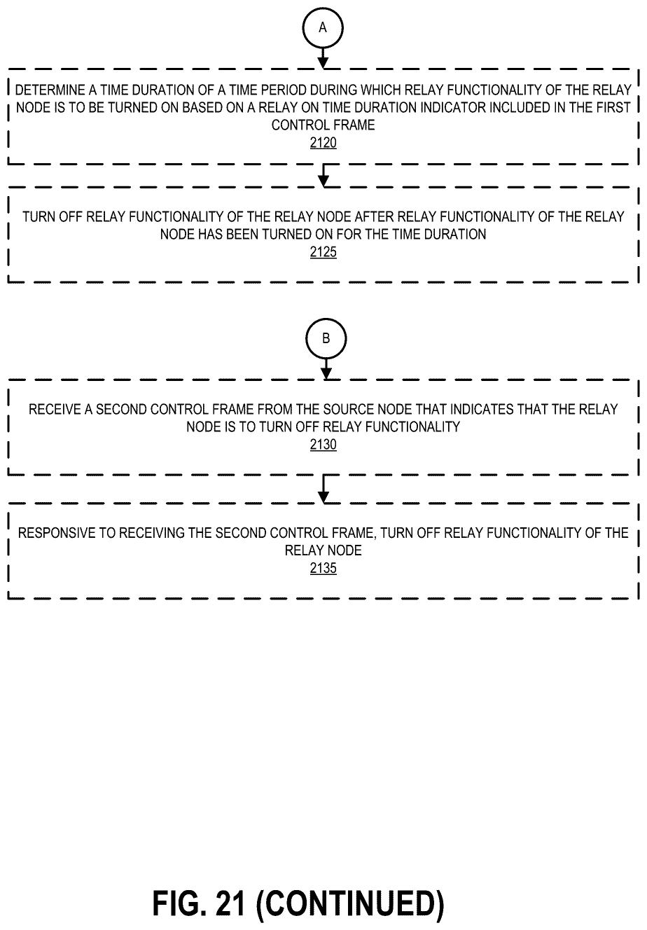

Turning now to FIG. 20, a method 2000 will be described for transmitting data to a destination node via a relay node, in accordance with an example embodiment. The method 2000 may be performed by a source node that wishes to transmit data to a destination node via a relay node. The source node may be a wireless device (e.g., wireless device 104).

Additionally, although shown in a particular order, in some embodiments the operations of the method 2000 (and the other methods shown in the other figures) may be performed in a different order. For example, although the operations of the method 2000 are shown in a sequential order, some of the operations may be performed in partially or entirely overlapping time periods.

At operation 2005, the source node transmits a first control frame to the relay node to indicate that the relay node is to turn on relay functionality.

In an embodiment, as shown in block 2010, the first control frame includes a relay on time duration indicator that indicates a time duration of a time period during which relay functionality of the relay node is to be turned on. In an embodiment, a relay on time duration indicator indicating a time duration of zero indicates that the relay node is to turn off relay functionality early.

In an embodiment, as shown in block 2015, the first control frame includes a relay on/off indicator that indicates that the relay node is to turn on relay functionality. In an embodiment, after transmitting the data frame, the source node transmits a second control frame to the relay node to indicate that the relay node is to turn off relay functionality. In an embodiment, the second control frame includes a relay on/off indicator that indicates that the relay node is to turn off relay functionality. In an embodiment, a frame transmitted before the first control frame includes an expired relay on duration indicator that indicates a time duration of a time period during which relay functionality of the relay node is to be turned on.

In an embodiment, as shown in block 2020, the first control frame includes a relay on time duration indicator that indicates a time duration of each time period of a plurality of recurring time periods during which relay functionality of the relay node is to be turned on and a periodicity of relay on time duration indicator that indicates a periodicity of the plurality of recurring time periods. In an embodiment, after transmitting the data frame, the source node transmits a second control frame to the relay node to indicate that the relay node is to turn off periodic relay functionality. In an embodiment, the second control frame includes a relay on time duration indicator that indicates a time duration of zero to indicate that the relay node is to turn off periodic relay functionality.

At operation 2025, after transmitting the first control frame, the source node transmits a data frame to the destination node via the relay node while relay functionality of the relay node is turned on the source node.

In an embodiment, at operation 2030, after transmitting the data frame, the source node transmits a second control frame to the relay node to indicate that the relay node is to turn off relay functionality.

In an embodiment, the first control frame is a type of MU RTS frame (e.g., MU RTS frame or MU RTS TXS frame) that includes a user info field that is addressed to the relay node.

In an embodiment, the MU RTS frame includes a relay on time duration indicator that indicates a time duration of each time period of a plurality of recurring time periods during which relay functionality of the relay node is to be turned on and a periodicity of relay on time duration indicator that indicates a periodicity of the plurality of recurring time periods.

In an embodiment, the user info field includes an allocation duration field that specifies a value that is less than or equal to a predefined value to indicate that the relay node is to turn on relay functionality, wherein the MU RTS frame further includes a duration/ID field that specifies a value that indicates a time duration of a time period during which relay functionality of the relay node is to be turned on. In an embodiment, a duration/ID field specifying a value that indicates a time duration of zero indicates that that the relay node is to turn off relay functionality early. In an embodiment, the predefined value is zero or corresponds to a combined time duration of a CTS frame and a SIFS interval.

In an embodiment, the MU RTS frame includes a relay on/off indication field that specifies a value that indicates that the relay node is to turn on relay functionality, wherein the user info field includes an allocation duration field that specifies a value that indicates a time duration of a time period during which relay functionality of the relay node is to be turned on. In an embodiment, an allocation duration field specifying a value that indicates a time duration of zero indicates that that the relay node is to turn off relay functionality early.

In an embodiment, the MU RTS frame includes a relay on time duration field that specifies a value that indicates a time duration of a time period during which relay functionality of the relay node is to be turned on, wherein the time duration being a non-zero time duration indicates that the relay node is to turn on relay functionality. In an embodiment, a relay on time duration field specifying a value that indicates a time duration of zero indicates that the relay node is to turn off relay functionality early.

In an embodiment, the MU RTS frame includes a relay on/off indication field that specifies a value that indicates that the relay node is to turn on relay functionality, wherein the MU RTS frame further includes a duration/ID field that specifies a value that indicates a time duration of a time period during which relay functionality of the relay node is to be turned on. In an embodiment, a duration/ID field specifying a value that indicates a time duration of zero indicates that that the relay node is to turn off relay functionality early.

In an embodiment, the first control frame is a trigger frame. In an embodiment, before transmitting the first control frame to the relay node, the source node transmits a RTS frame to the relay node and receives a CTS frame from the relay node to protect the transmission of the first control (trigger) frame.

In an embodiment, the source node receives a second control frame from the relay node as a response to the first control frame, wherein the relay node turns on relay functionality after transmitting the second control frame to the source node.

In an embodiment, while relay functionality of the relay node is turned on and before transmitting the data frame to the destination node, the source node transmits a RTS frame to the destination node via the relay node and receives a CTS frame from the destination node via the relay node to protect the transmission of the data frame.

In an embodiment, the relay node relays the data frame using a DF relay mechanism. In an embodiment, the relay node relays the data frame using an AF relay mechanism.

In an embodiment, the source node is a source AP, the relay node is a target AP, and the destination node is a non-AP STA that roams from the source AP to the target AP.

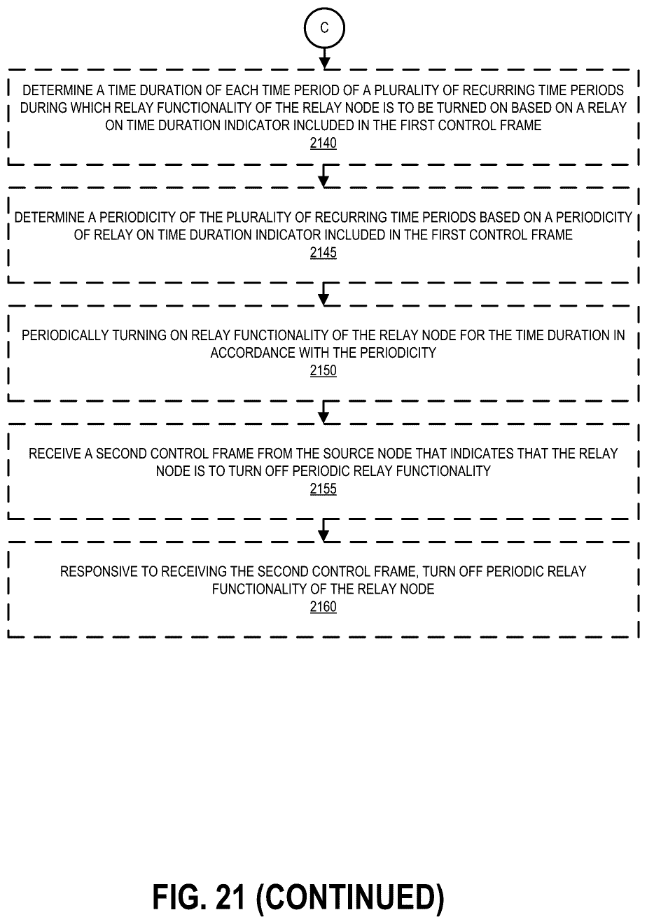

Turning now to FIG. 21, a method 2100 will be described for relaying data transmitted by a source node to a destination node, in accordance with an example embodiment. The method 2100 may be performed by a relay node that is to relay data transmitted by a source node to a destination node. The relay node may be a wireless device (e.g., wireless device 104).

At operation 2105, while relay functionality of the relay node is turned off, the relay node receives a first control frame from the source node that indicates that the relay node is to turn on relay functionality.

At operation 2110, responsive to receiving the first control frame, the relay node turns on relay functionality of the relay node.

At operation 2115, the relay node relays a data frame transmitted by the source node to the destination node while relay functionality of the relay node is turned on.

Depending on the implementation, the flow may follow path A, B, or C.

In path A, at operation 2120, the relay node determines a time duration of a time period during which relay functionality of the relay node is to be turned on based on a relay on time duration indicator included in the first control frame. At operation 2125, the relay node turns off relay functionality of the relay node after relay functionality of the relay node has been turned on for the time duration (i.e., when the time duration expires). In an embodiment, a relay on time duration indicator indicating a time duration of zero indicates that the relay node is to turn off relay functionality early.

In path B, at operation 2130, the relay node receives a second control frame from the source node that indicates that the relay node is to turn off relay functionality. At operation 2135, responsive to receiving the second control frame, the relay node turns off relay functionality of the relay node. In an embodiment, the first control frame includes a relay on/off indicator that indicates that the relay node is to turn on relay functionality. In an embodiment, the second control frame includes a relay on/off indicator that indicates that the relay node is to turn off relay functionality. In an embodiment, the relay node determines a time duration of a time period during which relay functionality of the relay node is to be turned on based on an expired relay on duration indicator included in a frame received before the first control frame or a predefined value. The relay node then turn off relay functionality of the relay node after relay functionality of the relay node has been turned on for the time duration.

In path C, at operation 2140, the relay node determines a time duration of each time period of a plurality of recurring time periods during which relay functionality of the relay node is to be turned on based on a relay on time duration indicator included in the first control frame. At operation 2145, the relay node determines a periodicity of the plurality of recurring time periods based on a periodicity of relay on time duration indicator included in the first control frame. At operation 2150, the relay node periodically turns on relay functionality of the relay node for the time duration in accordance with the periodicity.

In an embodiment, at operation 2155, the relay node receives a second control frame from the source node that indicates that the relay node is to turn off periodic relay functionality. At operation 2160, responsive to receiving the second control frame, the relay node turns off periodic relay functionality of the relay node. In an embodiment, the second control frame includes a relay on time duration indicator that indicates a time duration of zero to indicate that the relay node is to turn off periodic relay functionality.

In an embodiment, while relay functionality of the relay node is turned on, the relay node receives a second control frame from the source node that indicates that the relay node is to turn off relay functionality. Responsive to receiving the second control frame, the relay node may turn off relay functionality of the relay node.

In an embodiment, the first control frame is a type of MU RTS frame that includes a user info field that is addressed to the relay node.

In an embodiment, the MU RTS frame includes a relay on time duration indicator that indicates a time duration of each time period of a plurality of recurring time periods during which relay functionality of the relay node is to be turned on and a periodicity of relay on time duration indicator that indicates a periodicity of the plurality of recurring time periods.

In an embodiment, the relay node determines whether a value specified by an allocation duration field of the user info field is less than or equal to a predefined value, wherein relay functionality of the relay node is turned on responsive to determining that the value specified by the allocation duration field is less than or equal to the predefined value. The relay node may then determine a time duration of a time period during which relay functionality of the relay node is to be turned on based on a value specified by a duration/ID field included in the MU RTS frame. The relay node may then turn off relay functionality of the relay node after relay functionality of the relay node has been turned on for the time duration. In an embodiment, a duration/ID field specifying a value that indicates a time duration of zero indicates that that the relay node is to turn off relay functionality early. In an embodiment, the predefined value is zero or corresponds to a combined time duration of a CTS frame and a SIFS interval.

In an embodiment, the relay node determines whether to turn on relay functionality of the relay node based on a value specified by a relay on/off indication field included in the MU RTS frame, wherein relay functionality of the relay node is turned on responsive to determining that the value specified by the relay on/off indication field indicates that relay functionality of the relay node is to be turned on. The relay node may then determine a time duration of a time period during which relay functionality of the relay node is to be turned on based on a value specified by an allocation duration field included in the user info field. The relay node may then turn off relay functionality of the relay node after relay functionality of the relay node has been turned on for the time duration. In an embodiment, an allocation duration field specifying a value that indicates a time duration of zero indicates that that the relay node is to turn off relay functionality early.

In an embodiment, the relay node determines whether to turn on relay functionality of the relay node based on a value specified by a relay on time duration field included in the MU RTS frame, wherein relay functionality of the relay node is turned on responsive to determining that the value specified by the relay on time duration field indicates a non-zero time duration. The relay node may then determine a time duration of a time period during which relay functionality of the relay node is to be turned on based on the value specified by the relay on time duration field. The relay node may then turn off relay functionality of the relay node after relay functionality of the relay node has been turned on for the time duration. In an embodiment, a relay on time duration field specifying a value indicating a time duration of zero indicates that the relay node is to turn off relay functionality early.

In an embodiment, the relay node determines whether to turn on relay functionality of the relay node based on a value specified by a relay on/off indication field included in the MU RTS frame, wherein relay functionality of the relay node is turned on responsive to determining that the value specified by the relay on/off indication field indicates that relay functionality of the relay node is to be turned on. The relay node may then determine a time duration of a time period during which relay functionality of the relay node is to be turned on based on a value specified by a duration/ID field included in the MU RTS frame. The relay node may then turn off relay functionality of the relay node after relay functionality of the relay node has been turned on for the time duration. In an embodiment, a duration/ID field specifying a value that indicates a time duration of zero indicates that that the relay node is to turn off relay functionality early.

In an embodiment, the first control frame is a trigger frame. In an embodiment, before receiving the first control frame from the source node, the relay node receives a RTS frame from the source node and transmits a CTS frame to the source node to protect the transmission of the first control frame.

In an embodiment, responsive to receiving the first control frame, the relay node transmits a second control frame to the source node, wherein relay functionality of the relay node is turned on after transmitting the second control frame to the source node.

In an embodiment, while relay functionality of the relay node is turned on and before relaying the data frame to the destination node, the relay node relays a RTS frame transmitted by the source node to the destination node and relays a CTS frame transmitted by the destination node to the source node to protect the relaying of the data frame.

In an embodiment, the data frame is relayed using a DF relay mechanism. In an embodiment, the data frame is relayed using an AF relay mechanism.

In an embodiment, the source node is a source AP, the relay node is a target AP, and the destination node is a non-AP STA that roams from the source AP to the target AP.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a source node to transmit data to a destination node via a relay node, the method comprising:
transmitting a first control frame to the relay node to indicate that the relay node is to turn on relay functionality; and
after transmitting the first control frame, transmitting a data frame to the destination node via the relay node while relay functionality of the relay node is turned on.

2. The method of claim 1, wherein the first control frame includes a relay on time duration indicator that indicates a time duration of a time period during which relay functionality of the relay node is to be turned on.

3. The method of claim 2, wherein a relay on time duration indicator indicating a time duration of zero indicates that the relay node is to turn off relay functionality early.

4. The method of claim 1, wherein the first control frame includes a relay on/off indicator that indicates that the relay node is to turn on relay functionality.

5. The method of claim 4, further comprising:
after transmitting the data frame, transmitting a second control frame to the relay node to indicate that the relay node is to turn off relay functionality.

6. The method of claim 5, wherein the second control frame includes a relay on/off indicator that indicates that the relay node is to turn off relay functionality.

7. The method of claim 4, wherein a frame transmitted before the first control frame includes an expired relay on duration indicator that indicates a time duration of a time period during which relay functionality of the relay node is to be turned on.

8. The method of claim 1, wherein the first control frame includes a relay on time duration indicator that indicates a time duration of each time period of a plurality of recurring time periods during which relay functionality of the relay node is to be turned on and a periodicity of relay on time duration indicator that indicates a periodicity of the plurality of recurring time periods.

9. The method of claim 8, further comprising:
after transmitting the data frame, transmitting a second control frame to the relay node to indicate that the relay node is to turn off periodic relay functionality.

10. The method of claim 9, wherein the second control frame includes a relay on time duration indicator that indicates a time duration of zero to indicate that the relay node is to turn off periodic relay functionality.

11. The method of claim 1, wherein the first control frame is a type of multi-user request-to-send (MU RTS) frame that includes a user info field that is addressed to the relay node.

12. The method of claim 11, wherein the MU RTS frame includes a relay on time duration indicator that indicates a time duration of each time period of a plurality of recurring time periods during which relay functionality of the relay node is to be turned on and a periodicity of relay on time duration indicator that indicates a periodicity of the plurality of recurring time periods.

13. The method of claim 11, wherein the user info field includes an allocation duration field that specifies a value that is less than or equal to a predefined value to indicate that the relay node is to turn on relay functionality, wherein the MU RTS frame further includes a duration/ID field that specifies a value that indicates a time duration of a time period during which relay functionality of the relay node is to be turned on.

14. The method of claim 13, wherein a duration/ID field specifying a value that indicates a time duration of zero indicates that that the relay node is to turn off relay functionality early.

15. The method of claim 13, wherein the predefined value is zero or corresponds to a combined time duration of a clear-to-send (CTS) frame and a short interframe space (SIFS) interval.

16. The method of claim 11, wherein the MU RTS frame includes a relay on/off indication field that specifies a value that indicates that the relay node is to turn on relay functionality, wherein the user info field includes an allocation duration field that specifies a value that indicates a time duration of a time period during which relay functionality of the relay node is to be turned on.

17. The method of claim 16, wherein an allocation duration field specifying a value that indicates a time duration of zero indicates that that the relay node is to turn off relay functionality early.

18. The method of claim of claim 11, wherein the MU RTS frame includes a relay on time duration field that specifies a value that indicates a time duration of a time period during which relay functionality of the relay node is to be turned on, wherein the time duration being a non-zero time duration indicates that the relay node is to turn on relay functionality.

19. The method of claim 18, wherein a relay on time duration field specifying a value that indicates a time duration of zero indicates that the relay node is to turn off relay functionality early.

20. The method of claim 11, wherein the MU RTS frame includes a relay on/off indication field that specifies a value that indicates that the relay node is to turn on relay functionality, wherein the MU RTS frame further includes a duration/ID field that specifies a value that indicates a time duration of a time period during which relay functionality of the relay node is to be turned on.

21. The method of claim 20, wherein a duration/ID field specifying a value that indicates a time duration of zero indicates that that the relay node is to turn off relay functionality early.

22. The method of claim 1, wherein the first control frame is a trigger frame.

23. The method of claim 22, further comprising:
before transmitting the first control frame to the relay node, transmitting a request-to-send (RTS) frame to the relay node and receiving a clear-to-send (CTS) frame from the relay node to protect the transmission of the first control frame.

24. The method of claim 1, further comprising:
receiving a second control frame from the relay node as a response to the first control frame, wherein the relay node turns on relay functionality after transmitting the second control frame to the source node.

25. The method of claim 1, further comprising:
while relay functionality of the relay node is turned on and before transmitting the data frame to the destination node, transmitting a request-to-send (RTS) frame to the destination node via the relay node and receiving a clear-to-send (CTS) frame from the destination node via the relay node to protect the transmission of the data frame.

26. The method of claim 1, wherein the relay node relays the data frame using a decode and forward (DF) relay mechanism.

27. The method of claim 1, wherein the relay node relays the data frame using an amplify and forward (AF) relay mechanism.

28. A method performed by a relay node to relay data transmitted by a source node to a destination node, the method comprising:
while relay functionality of the relay node is turned off, receiving a first control frame from the source node that indicates that the relay node is to turn on relay functionality;
responsive to receiving the first control frame, turning on relay functionality of the relay node; and
relaying a data frame transmitted by the source node to the destination node while relay functionality of the relay node is turned on.

29. The method of claim 28, further comprising:
while relay functionality of the relay node is turned on, receiving a second control frame from the source node that indicates that the relay node is to turn off relay functionality; and
responsive to receiving the second control frame, turning off relay functionality of the relay node.

30. The method of claim 28, further comprising:
determining a time duration of a time period during which relay functionality of the relay node is to be turned on based on a relay on time duration indicator included in the first control frame; and
turning off relay functionality of the relay node after relay functionality of the relay node has been turned on for the time duration.

31. The method of claim 30, wherein a relay on time duration indicator indicating a time duration of zero indicates that the relay node is to turn off relay functionality early.

32. The method of claim 28, wherein the first control frame includes a relay on/off indicator that indicates that the relay node is to turn on relay functionality.

33. The method of claim 32, wherein the method further comprises:
receiving a second control frame from the source node that indicates that the relay node is to turn off relay functionality; and
responsive to receiving the second control frame, turning off relay functionality of the relay node.

34. The method of claim 33, wherein the second control frame includes a relay on/off indicator that indicates that the relay node is to turn off relay functionality.

35. The method of claim 32, further comprising:
determining a time duration of a time period during which relay functionality of the relay node is to be turned on based on an expired relay on duration indicator included in a frame received before the first control frame or a predefined value; and
turning off relay functionality of the relay node after relay functionality of the relay node has been turned on for the time duration.

36. The method of claim 28, further comprising:
determining a time duration of each time period of a plurality of recurring time periods during which relay functionality of the relay node is to be turned on based on a relay on time duration indicator included in the first control frame;
determining a periodicity of the plurality of recurring time periods based on a periodicity of relay on time duration indicator included in the first control frame; and
periodically turning on relay functionality of the relay node for the time duration in accordance with the periodicity.

37. The method of claim 36, further comprising:
receiving a second control frame from the source node that indicates that the relay node is to turn off periodic relay functionality; and
responsive to receiving the second control frame, turning off periodic relay functionality of the relay node.

38. The method of claim 37, wherein the second control frame includes a relay on time duration indicator that indicates a time duration of zero to indicate that the relay node is to turn off periodic relay functionality.

39. The method of claim 28, wherein the first control frame is a type of multi-user request-to-send (MU RTS) frame that includes a user info field that is addressed to the relay node.

40. The method of claim 39, wherein the MU RTS frame includes a relay on time duration indicator that indicates a time duration of each time period of a plurality of recurring time periods during which relay functionality of the relay node is to be turned on and a periodicity of relay on time duration indicator that indicates a periodicity of the plurality of recurring time periods.

41. The method of claim 39, further comprising:
determining whether a value specified by an allocation duration field of the user info field is less than or equal to a predefined value, wherein relay functionality of the relay node is turned on responsive to determining that the value specified by the allocation duration field is less than or equal to the predefined value;
determining a time duration of a time period during which relay functionality of the relay node is to be turned on based on a value specified by a duration/ID field included in the MU RTS frame; and
turning off relay functionality of the relay node after relay functionality of the relay node has been turned on for the time duration.

42. The method of claim 41, wherein a duration/ID field specifying a value that indicates a time duration of zero indicates that that the relay node is to turn off relay functionality early.

43. The method of claim 41, wherein the predefined value is zero or corresponds to a combined time duration of a clear-to-send (CTS) frame and a short interframe space (SIFS) interval.

44. The method of claim 39, further comprising:
determining whether to turn on relay functionality of the relay node based on a value specified by a relay on/off indication field included in the MU RTS frame, wherein relay functionality of the relay node is turned on responsive to determining that the value specified by the relay on/off indication field indicates that relay functionality of the relay node is to be turned on;
determining a time duration of a time period during which relay functionality of the relay node is to be turned on based on a value specified by an allocation duration field included in the user info field; and
turning off relay functionality of the relay node after relay functionality of the relay node has been turned on for the time duration.

45. The method of claim 44, wherein an allocation duration field specifying a value that indicates a time duration of zero indicates that that the relay node is to turn off relay functionality early.

46. The method of claim 39, further comprising:
determining whether to turn on relay functionality of the relay node based on a value specified by a relay on time duration field included in the MU RTS frame, wherein relay functionality of the relay node is turned on responsive to determining that the value specified by the relay on time duration field indicates a non-zero time duration;
determining a time duration of a time period during which relay functionality of the relay node is to be turned on based on the value specified by the relay on time duration field; and
turning off relay functionality of the relay node after relay functionality of the relay node has been turned on for the time duration.

47. The method of claim 46, wherein a relay on time duration field specifying a value indicating a time duration of zero indicates that the relay node is to turn off relay functionality early.

48. The method of claim 39, further comprising:
determining whether to turn on relay functionality of the relay node based on a value specified by a relay on/off indication field included in the MU RTS frame, wherein relay functionality of the relay node is turned on responsive to determining that the value specified by the relay on/off indication field indicates that relay functionality of the relay node is to be turned on;
determining a time duration of a time period during which relay functionality of the relay node is to be turned on based on a value specified by a duration/ID field included in the MU RTS frame; and
turning off relay functionality of the relay node after relay functionality of the relay node has been turned on for the time duration.

49. The method of claim 48, wherein a duration/ID field specifying a value that indicates a time duration of zero indicates that that the relay node is to turn off relay functionality early.

50. The method of claim 28, wherein the first control frame is a trigger frame.

51. The method of claim 50, further comprising:
before receiving the first control frame from the source node, receiving a request-to-send (RTS) frame from the source node and transmitting a clear-to-send (CTS) frame to the source node to protect the transmission of the first control frame.

52. The method of claim 28, further comprising:
responsive to receiving the first control frame, transmitting a second control frame to the source node, wherein relay functionality of the relay node is turned on after transmitting the second control frame to the source node.

53. The method of claim 28, further comprising:
while relay functionality of the relay node is turned on and before relaying the data frame to the destination node, relaying a request-to-send (RTS) frame transmitted by the source node to the destination node and relaying a clear-to-send (CTS) frame transmitted by the destination node to the source node to protect the relaying of the data frame.

54. The method of claim 28, wherein the data frame is relayed using a decode and forward (DF) relay mechanism.

55. The method of claim 28, wherein the data frame is relayed using an amplify and forward (AF) relay mechanism.

56. The method of claim 28, wherein the source node is a source access point (AP), the relay node is a target AP, and the destination node is a non-AP station (STA) that roams from the source AP to the target AP.
